(19) United States
(12) Patent Application Publication
(10) Pub. No.: US 2024/0019978 A1
(43) Pub. Date: Jan. 18, 2024

(54) METHODS AND SYSTEMS FOR MONITORING AND VISUALLY REPRESENTING ATTRIBUTES OF OBJECTS EXECUTING IN A DATA CENTER

(71) Applicant: VMWARE, INC., Palo Alto, CA (US)

(72) Inventor: KRISHNAMOORTHY BALARAMAN, Bangalore (IN)

(21) Appl. No.: 17/961,586

(22) Filed: Oct. 7, 2022

(30) Foreign Application Priority Data
Jul. 15, 2022 (IN) 202241040572

(51) Int. Cl. G06F 3/04812; G06F 3/0482; G06F 3/04817; G06T 11/20

(52) U.S. Cl. CPC G06F 3/04812; G06F 3/0482; G06F 3/04817; G06T 11/206

(57) ABSTRACT

Automated computer-implemented methods and systems for monitoring and visually representing attributes of objects executing in a data center are described. Attribute values of the attributes are regularly updated in a database of attributes of the objects for a current time interval. The attribute values obtained in the current time interval are mapped to pixel dimensions of an electronic visual display device. The pixel dimensions correspond to dimensions of features of object icons that represent the objects. The object icons are displayed with the feature dimensions in a graphical user interface (“GUI”) on the electronic visual display device. Each object icon is a visual indicator of a current state of attributes of an object. The collection of object icons displayed reveals at a glance relative differences between attributes of the objects in the current time interval.

### TECHNICAL FIELD

This disclosure is directed to methods and systems for monitoring and reporting attributes of objects executing in a data center.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The number and size of data centers has grown in recent years to meet the increasing demand for information technology (“IT”) services, such as running applications for organizations that provide business services, web services, streaming services, and other cloud services to millions of users each day.

Advancements in virtualization and software technologies provide many advantages for development and deployment of applications in data centers. Enterprises, governments, and other organizations now conduct commerce, provide services over the internet, and process large volumes of data using distributed applications executed in data centers. A distributed application comprises multiple software components that are executed in virtual machines (“VMs”), or in containers, on multiple server computers of a data center. The software components communicate and coordinate data processing and data stores to appear as a single coherent application that provides services to end users. Consider, for example, a distributed application that provides banking services to users via a bank website or a mobile application (“mobile app”). Certain software components provide front-end services that enable users to input banking requests and receive responses to requests via the website or the mobile app. Each user only sees the features provided by the website or mobile application. Other software components provide back-end services that are executed across a distributed computing system. These services include processing user banking requests, maintaining storage of user banking information in data stores, and retrieving user information from data stores.

Data centers run tens of thousands of distributed applications in VMs and containers that can be scaled up or down to meet customer and client demands. For example, VMs that provide a service can be created to satisfy increasing demand for services and deleted when demand for the services decreases. VMs and containers can also be migrated to different host server computers within a data center to optimize use of resources. Organizations that depend on data centers to run their applications cannot afford performance problems that result in downtime or slow execution of their applications. Performance problems frustrate users, damage a brand name, result in lost revenue, and, in some cases, deny people access to vital services. As a result, data center system administrators are tasked with monitoring attributes of tens of thousands of data center objects, including VMs, containers, server computers, and network devices. An attribute represents a particular property, state, or characteristic of a data center object. System administrators are expected to take immediate corrective action when an attribute of the objects indicates a performance problem. To aid system administrators with detection of performance problems, data center management tools have been developed to collect attribute information and display a table that contains a list of objects and numerical values of the attributes in a console. The attribute values are periodically updated so that system administrators have access to the latest in formation.

However, data tables that display the latest attribute values of data center objects are not helpful in identifying relative differences or changes in attributes of data center objects. A data table for thousands of VMs, for example, will contain tens of thousands of numerical table entries that each represent the current state of an object attribute. The numerical entries change periodically to represent the current state of the attributes. As a result, the process of visually scanning tables for relative differences in attributes is extremely tedious and error prone because human beings cannot, as a practical matter, mentally evaluate in real time thousands of numerical table entries at a glance. People often become bored and tired of inspecting table entries even for short periods, resulting in an increased likelihood that relative differences in attributes of objects will go undetected. As a result, system administrators seek methods and systems that enable system administrators to rapidly detect relative differences in the attributes of objects without having to scroll through data tables with numerous periodically changing numerical table entries.

### SUMMARY

This disclosure is directed to automated computer-implemented methods and systems for monitoring and visually representing attributes of objects executing in a data center. Attribute values are regularly updated in a database of attributes of the objects for a current time interval. An attribute represents a particular property, state, or characteristic of an object. The objects can be, for example, virtual machines, containers, host computers, and network devices of the data center. The attribute values obtained in the current time interval are mapped to pixel dimensions of an electronic visual display device. The pixel dimensions correspond to dimensions of features of object icons that represent the objects. The object icons are displayed with the feature dimensions in a graphical user interface (“GUI”) on the electronic visual display device. Each object icon is a visual indicator of a current state of attributes of an object. The collection of object icons displayed reveals to a viewer at a glance the relative differences between attributes of the objects in the current time interval.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B show examples of operations manager receiving metrics from physical and virtual objects of the data center.

FIG. 15 shows an example of a timeline partitioned into time intervals and an example graphical user interface (“GUI”) that displays values of attribute of objects executing in a data center.

FIG. 16 shows a table of example VM attributes that can be used to monitor VMs executing in a data center.

FIGS. 17A-17C show an example of facial features of a facial icon that represent attributes of a VM.

FIG. 18 shows an example table of VMs and corresponding attribute values.

FIGS. 19A-19C show example distributions of binary, categorical, and continuous range attributes.

FIGS. 20A-20C show examples of how pixels of a height of hair facial feature changes with different attribute values.

FIG. 21 shows an example of mapping values of a binary attribute to pixel dimensions.

FIG. 22 shows examples of pixel dimensions and corresponding heights of eyes of facial icons.

FIG. 23 shows an example of mapping values in a boxplot of attribute values to pixel dimensions.

FIG. 24 shows examples of attribute values mapped to pixel dimensions in accordance with a mapping.

FIG. 25 shows examples of pixel dimensions and corresponding heights of hair of a facial icon.

FIG. 26 show examples of facial icons with variations in facial features that represent changes in attributes of four VMs.

FIG. 27 shows an example of a GUI that displays facial icons of the VMs running in a data center.

FIG. 28 shows an example of a cursor placed over a facial icon a GUI to create a pop-up window.

FIG. 29 shows an example of a GUI that displays facial icons of hosts running in a data center.

FIG. 30 shows a table of example group attributes and corresponding facial features of facial icons that represent multiple objects of a software defined data center.

FIG. 31 shows six example boxplots of attribute values for six group attributes.

FIG. 32 shows an example of a GUI that displays facial icons that represent relative changes in group attributes over 30 days.

FIG. 33 shows an example of a cursor placed over a facial icon to create a pop-up window that reveals values of group attributes obtain for a day.

FIG. 34 shows an example GUI may present a drop-down menu that enables a user to select a particular type of object icon to represent attributes of objects running in a data center.

FIG. 35A shows an example of a flower icon that can be used to represent various attributes.

FIG. 35B shows an example of a dog face icon that can be used to represent various attributes.

FIG. 36 is a flow diagram of a method for monitoring and visually representing attributes of objects executing in a data center.

FIG. 37 is a flow diagram illustrating an example implementation of the “map attribute values of attributes to dimensions of features of object icons that represent the objects” procedure performed in FIG. 36.

FIG. 38 is a flow diagram illustrating an example implementation of the “map binary attribute values to pixel dimensions of features of object icons” procedure performed in FIG. 37.

FIG. 39 is a flow diagram illustrating an example implementation of the “map non-binary attribute values to pixel dimensions of features of object icons” procedure performed in FIG. 37.

FIG. 40 is a flow diagram illustrating an example implementation of the “map binary attribute values to pixel dimensions of features of object icons” procedure performed in FIG. 36.

### DETAILED DESCRIPTION

This disclosure presents automated computer-implemented methods and systems for monitoring and visually representing attributes of objects executing in a data center. In a first subsection, computer hardware, complex computational systems, and virtualization are described. Computer-implemented methods and systems for monitoring and visually representing attributes of objects executing in a data center are described below in a second subsection.

Computer Hardware, Complex Computational Systems, and Virtualization

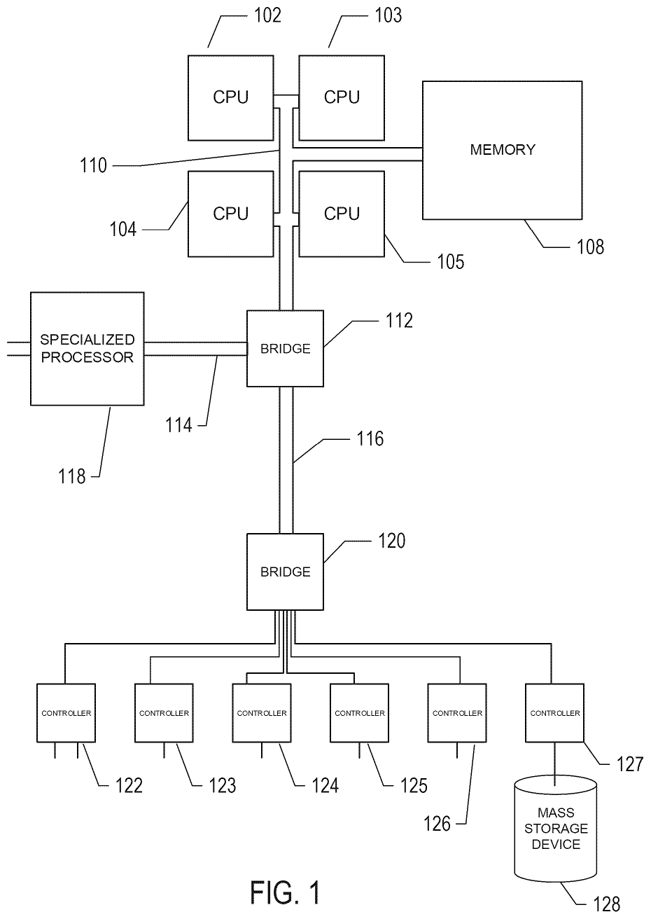

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

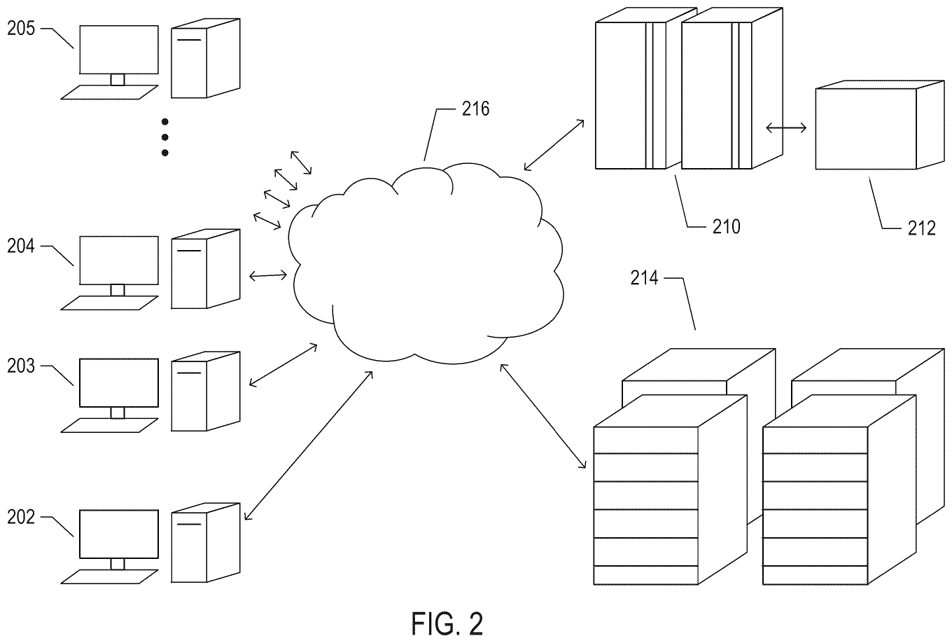

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

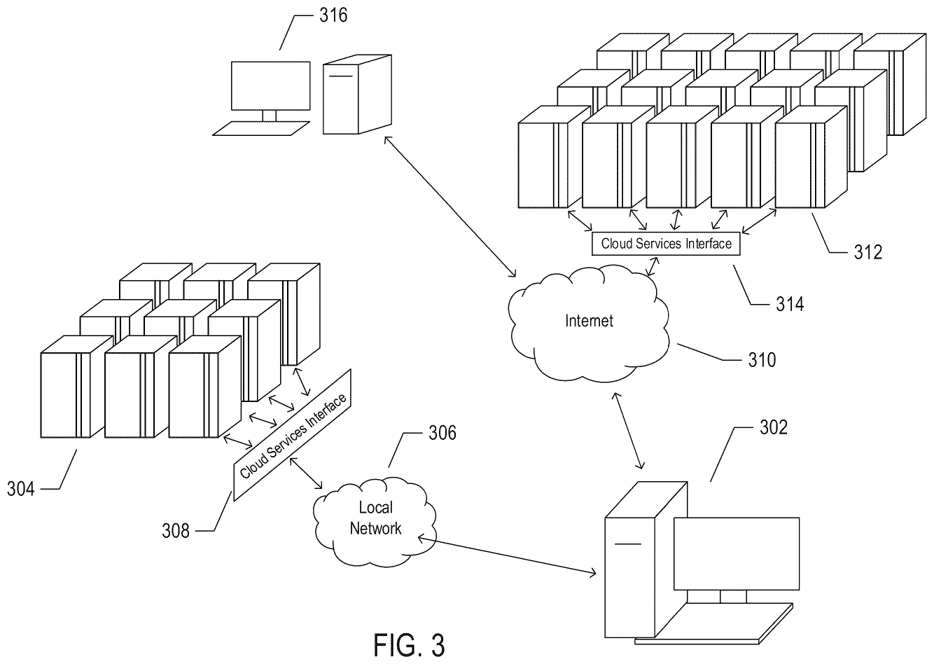

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

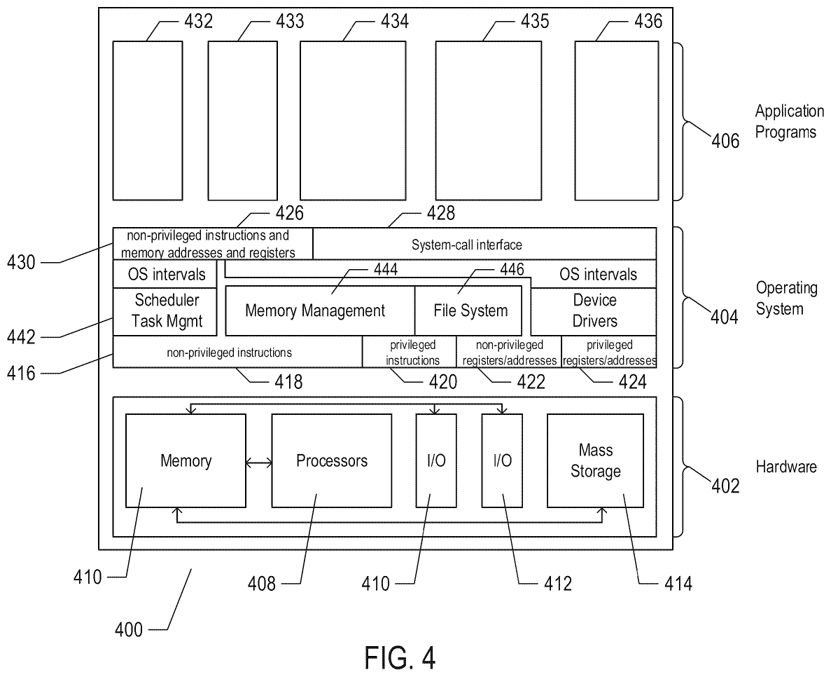

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402: (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which the) are targeted, creating compatibility issues that are particularly difficult to manage in large distributed systems.

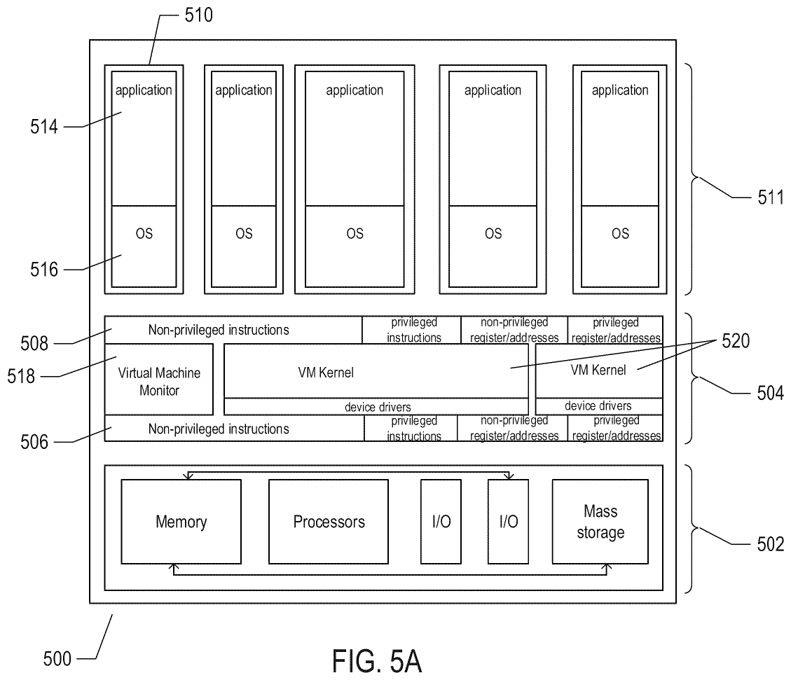

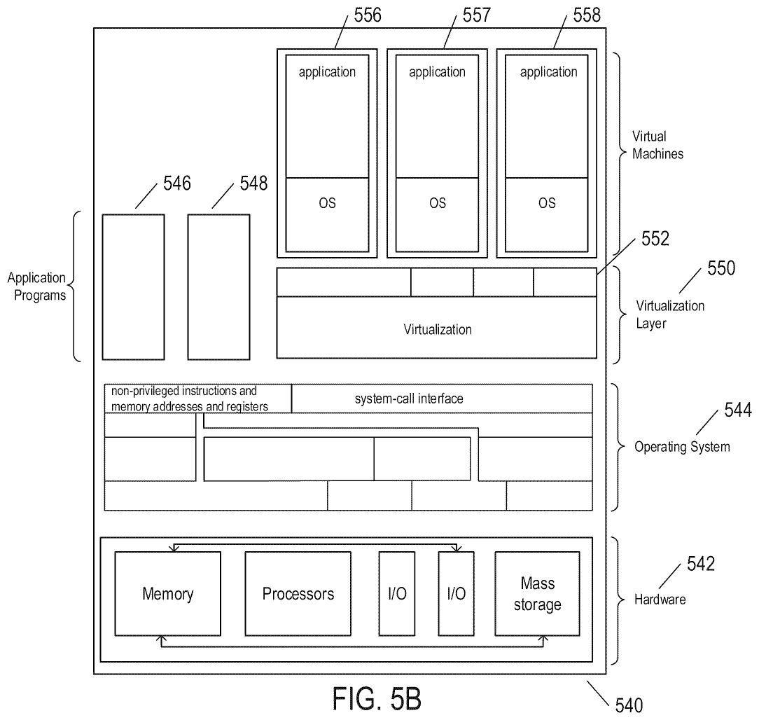

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system.” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

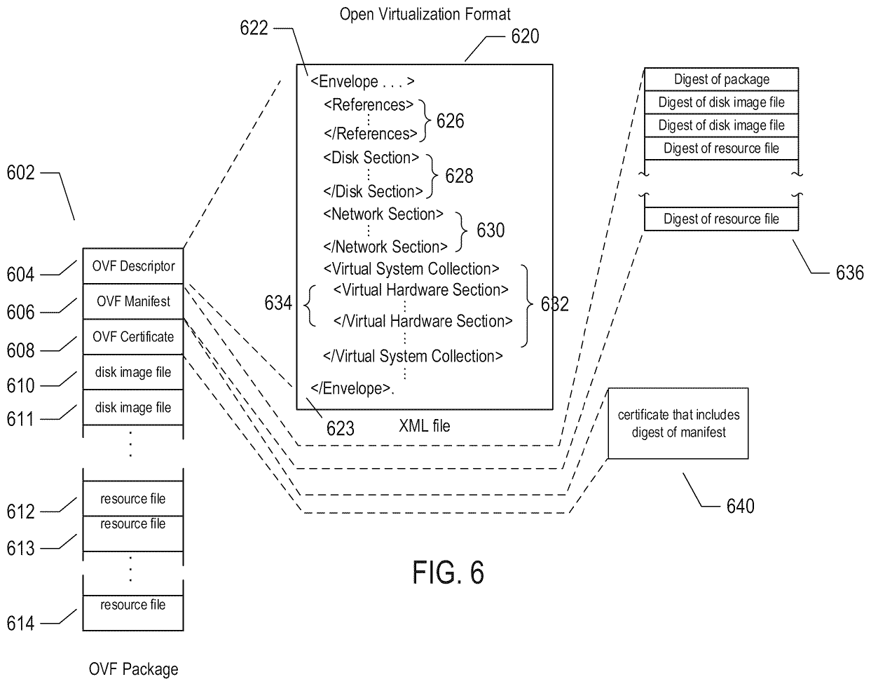

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

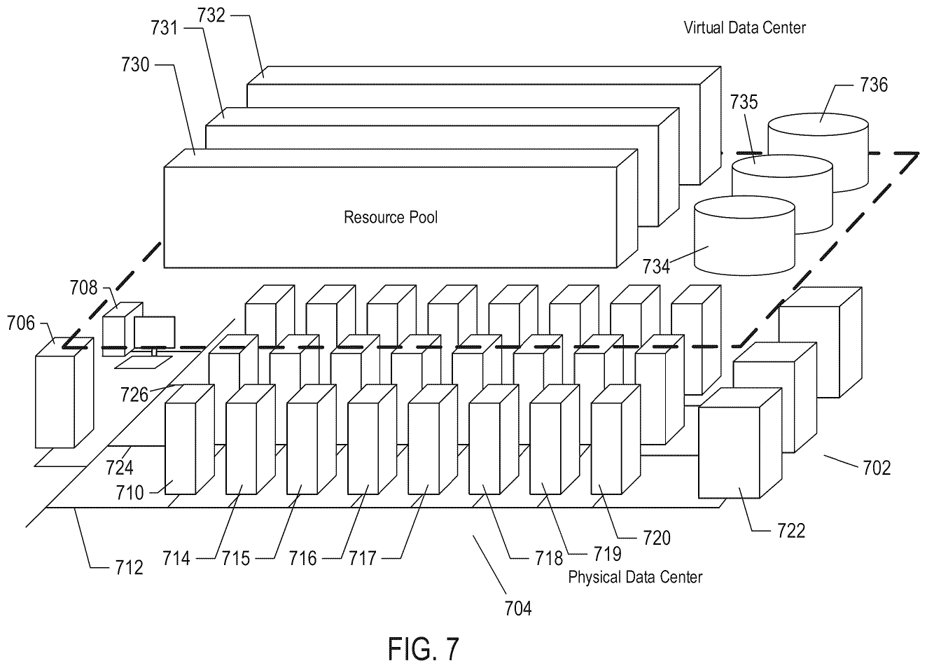

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interlace allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

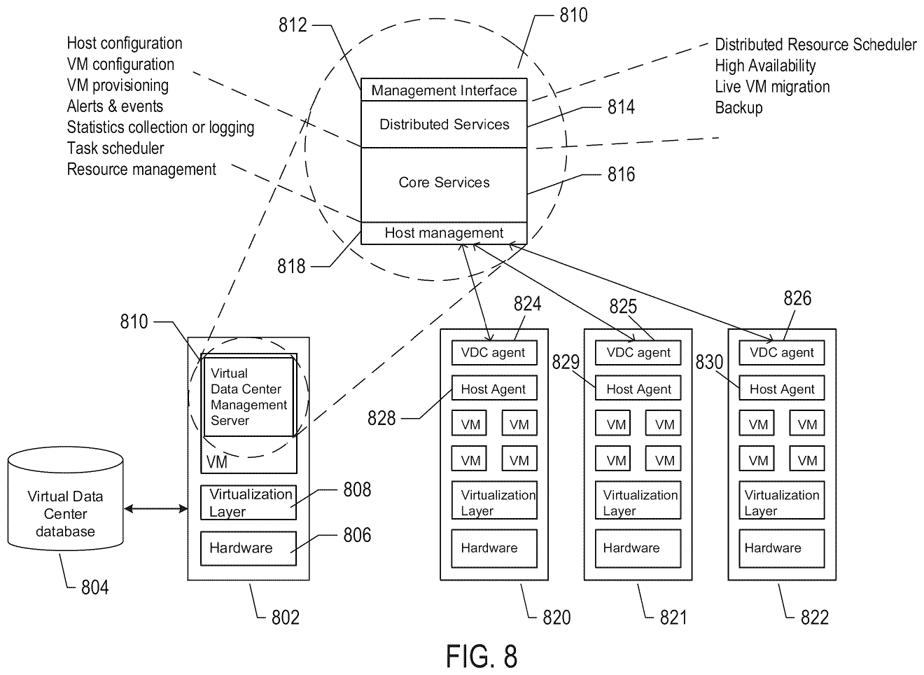

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

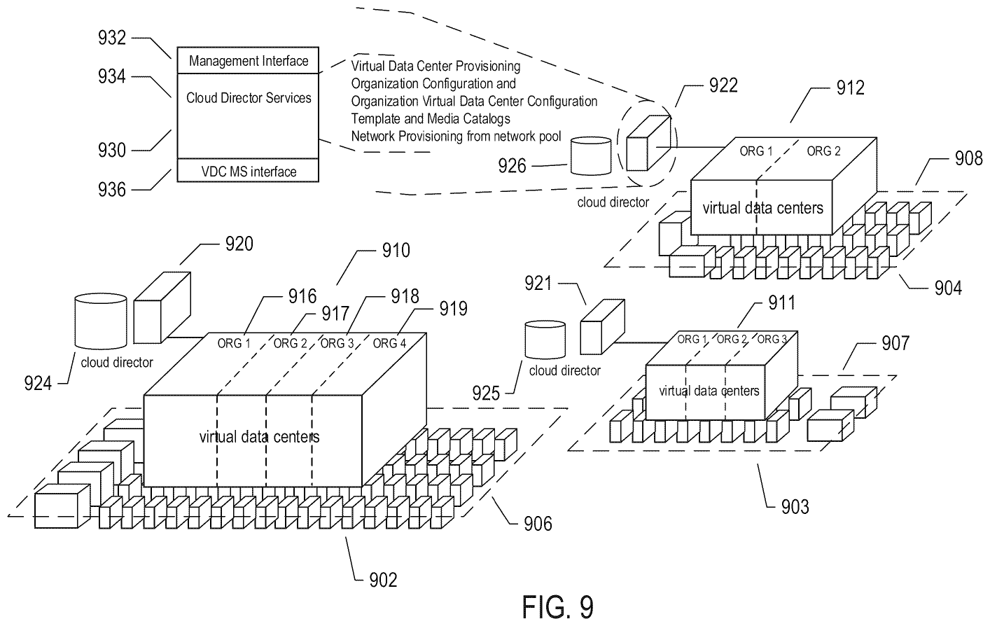

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

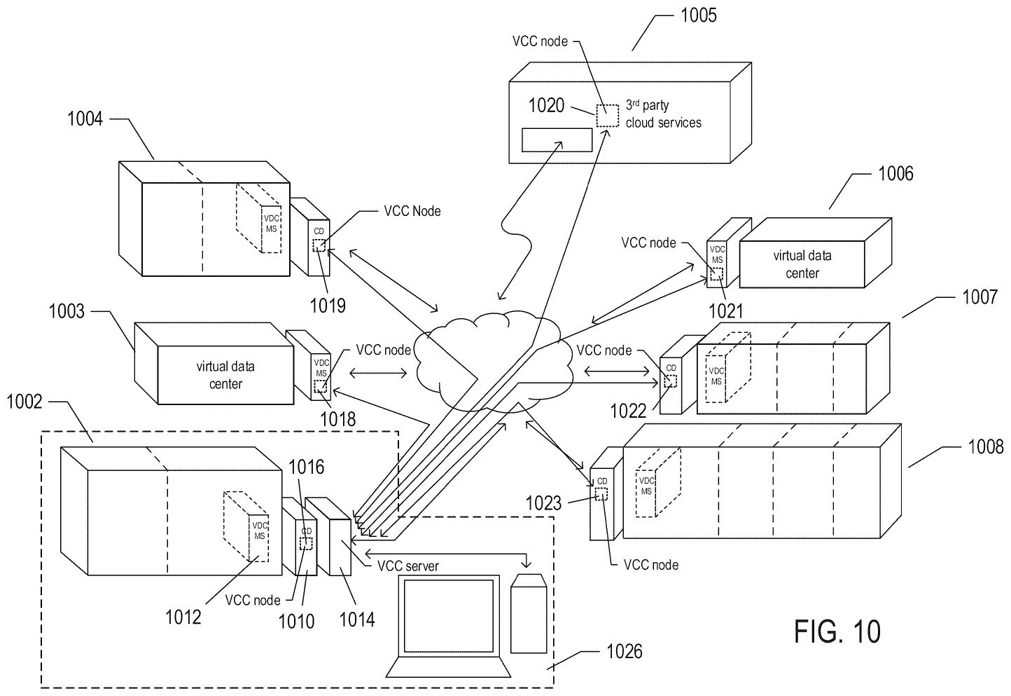

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-102′. The VCC server provides a VCC server interface that can be displayed on a local or remote terminal. PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above. OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

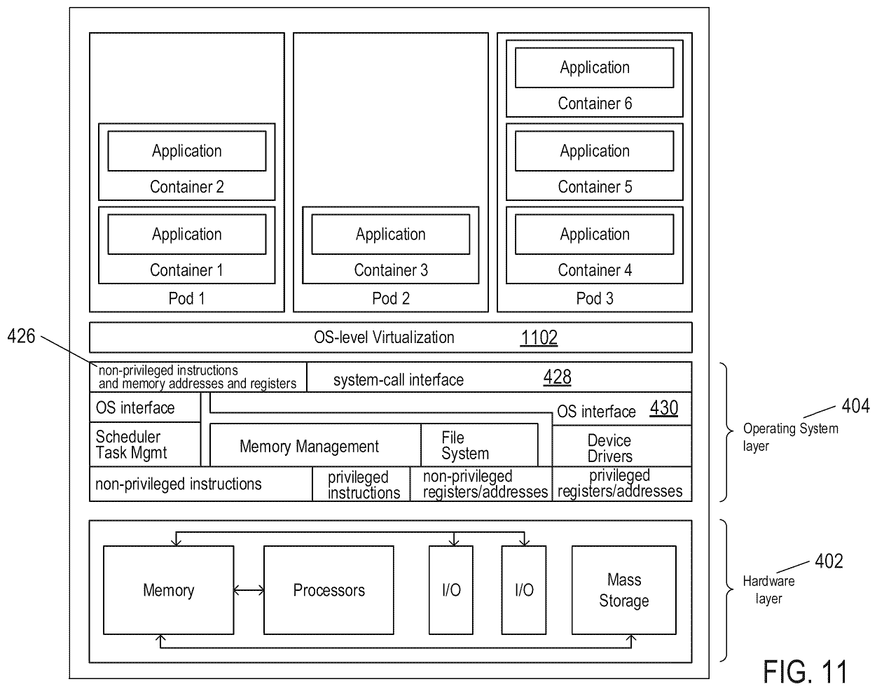

FIG. 11 shows an example server computer used to host three pods. As discussed above with reference to FIG. 4, an operating system layer 404 runs on the hardware layer 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly on the operating system layer 404, OSL virtualization involves an OSL virtualization layer 1102 that provides operating-system interfaces to each of the pods 1-3. In this example, applications are run separately in containers 1-6 that are in turn run in pods identified as Pod 1, Pod 2, and Pod 3. Each pod runs one or more containers with shared storage and network resources, according to a specification for how to run the containers. For example, Pod 1 runs an application 1104 in container 1 and another application 1106 in a container identified as container 2.

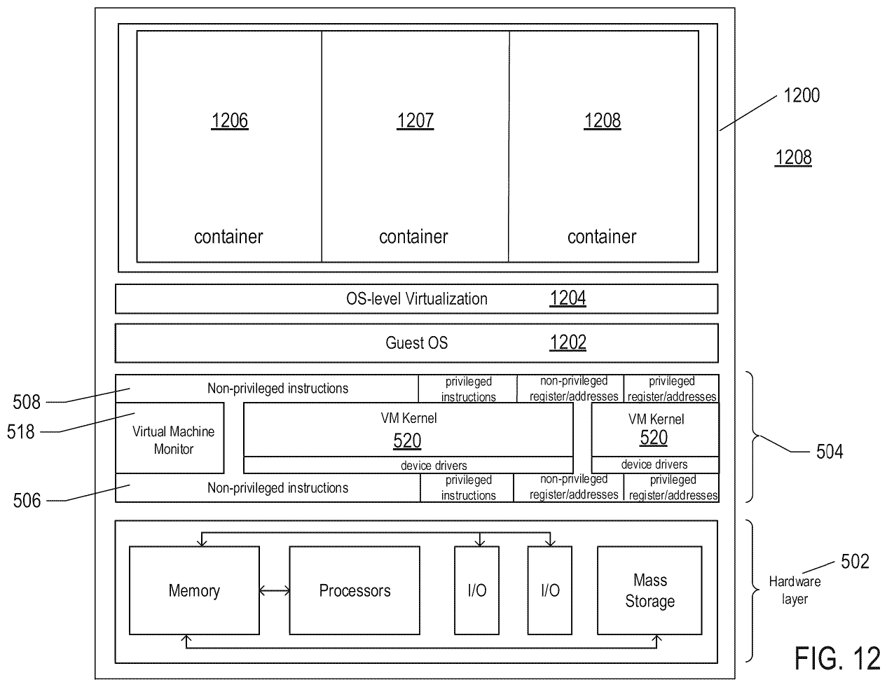

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Methods and Systems for Monitoring and Visually Representing Attributes of Objects Executing in a Data Center

This disclosure presents automated computer-implemented methods and systems that monitor attributes of objects executing in a data center and visually displays the attributes as object icons in a graphical user interface (“GUI”). The automated methods are performed by an operations manager that collects attribute information of data center objects and utilizes the attribute information to create and visually display object icons that represent the current state of attributes of the objects in the GUI. Each icon includes visually recognizable features that serve as visual indicators of the current states of the attributes of a data center object. The operations manager automatically updates the icons based on the latest real time attribute information to visually represent the current relative states of the attributes of the objects. The collection of icons displayed in the GUI reveal at a glance the relative differences between attributes of the objects, thereby enabling a viewer to rapidly determine which objects are different from the other objects and identify objects that may be in need of immediate attention.

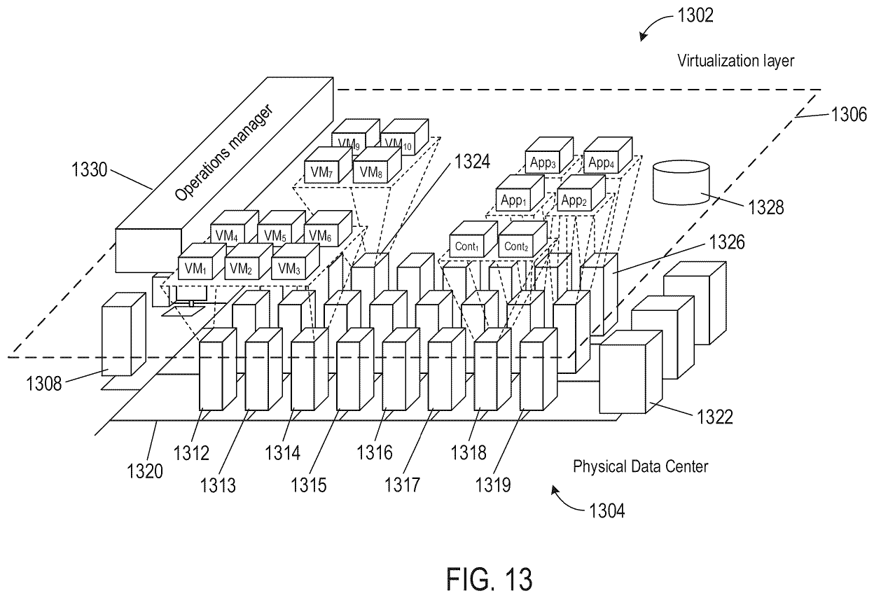

FIG. 13 shows an example of a virtualization layer 1302 located above a physical data center 1304. For the sake of illustration, the virtualization layer 1302 is separated from the data center 1304 by a virtual-interface plane 1306. The data center 1304 is an example of a distributed computing system. The data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects executing in the virtualization layer 1302. Different data centers may include many different types of computers, networks, data-storage systems, and devices connected according to many different types of connection topologies.

The virtual-interface plane 1306 abstracts the resources of the physical data center 1304 to one or more VDCs comprising the virtual objects and one or more virtual data stores, such as virtual data store 1328. For example, one VDC may comprise the VMs running on server computer 1324 and virtual data store 1328. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇. VM₈, VM₉, VM₁₀. Other server computers may host applications as described above with reference to FIG. 4. For example, server computer 1326 hosts an application identified as App₄.

Computer-implemented methods described herein are performed by an operations manager 1330 that is executed in one or more VMs on the administration computer system 1308. The operations manager 1330 provides several interfaces, such as graphical user interfaces (“GUIs”), for data center management to system administrators and application owners. The operations manager 1330 receives attribute information regarding the states of various attributes of objects of the data center. An “object” can be a physical object, such as a server computer or a network device, or an object can be a virtual object, such as an application, a VM, a virtual network device, a pod, or a container.

An attribute represents a particular property, state, or characteristic of a data center object. The attribute information includes power state of an object, amount of memory of an object, number of CPUs, number of ethernet cards, or number of virtual disks. Attributes may also include metric data that reveals the current state of an object. Metric data is time-series data that may be generated by an operating system, a resource, or by an object itself. A stream of metric data comprises a sequence of time-ordered metric values that are recorded in spaced points in time called “time stamps.” A stream of metric data is simply called a “metric” and is denoted by (xₜ)ᵢ₌₁^{N}=(x(tᵢ))ᵢ₌₁^{N}, where N is the number of metric values in a sequence of metric values: xᵢ=x(tᵢ) is a metric value: tᵢ is a time stamp indicating when the metric value was recorded in a data-storage device; and subscript i is a time stamp index i=1, . . . , N. A metric can represent usage of a physical or virtual resource. For example, a metric ma represent CPU usage by the object over time. A metric may represent the amount of virtual memory assigned to the object over time. A metric may represent network throughput for a server computer over time. A metric may also represent object performance, such as CPU contention, response time to requests, and wait time for access to a resource of an object over time. A metric may also represent network flows, or simply net flows, used to monitor network traffic flow. Network flows include percentage of packets dropped, data transmission rate, data receiver rate, and total throughput.

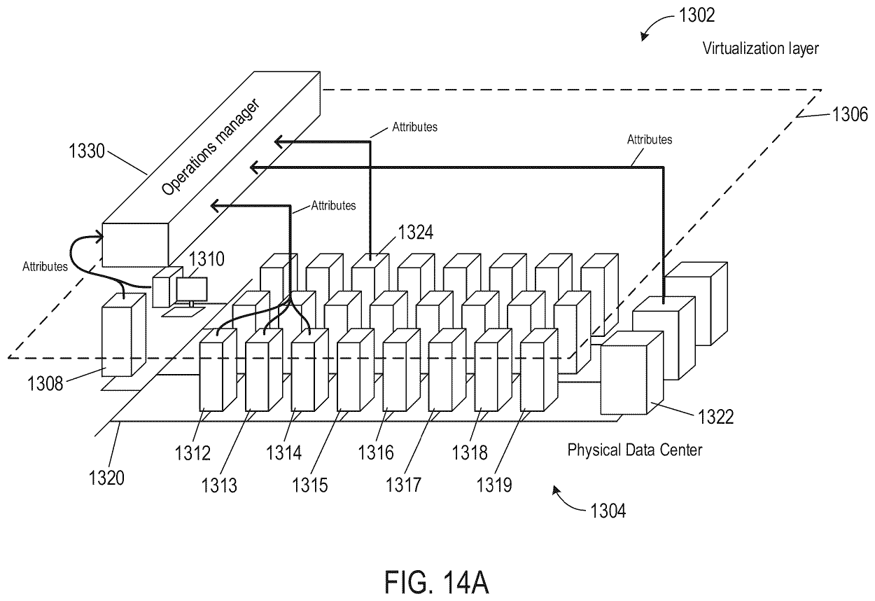

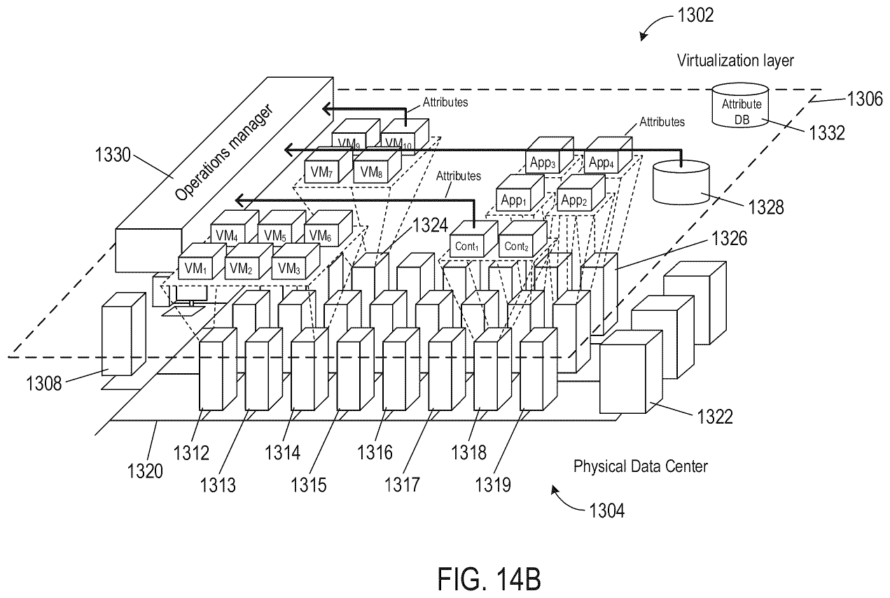

FIGS. 14A-14B show examples of the operations manager 1330 receiving attribute information from physical and virtual objects of the data center 1304. Directional arrows represent attribute information sent from physical and virtual resources to the operations manager 1330. In FIG. 14A, the operating systems of PC 1310, server computers 1308 and 1324, and mass-storage array 1322 send attribute information to the operations manager 1330. A cluster of server computers 1312-1314 send attribute information to the operations manager 1330. In FIG. 14B, the VMs, containers, applications, and virtual storage may independently send metrics to the operations manager 1330. Certain objects may send metrics as the metric is generated while other objects may only send metrics at certain times or when requested to send metrics by the operations manager 1330. The operations manager 1330 stores the attribute information in an attribute database 1332 and retrieves the attribute information as described below to create object icons that are displayed in a GUI. Each object icon is a visual indicator of a current state of attributes of an object executing in the data center.

Conventional operation managers collect attribute information associated with numerous objects of a data center in time intervals and display the metrics and attribute information in data tables on a monitor, such as a console of a system administrator of a data center. The system administrator is expected to visually identify attribute values that are an indication of attribute changes.

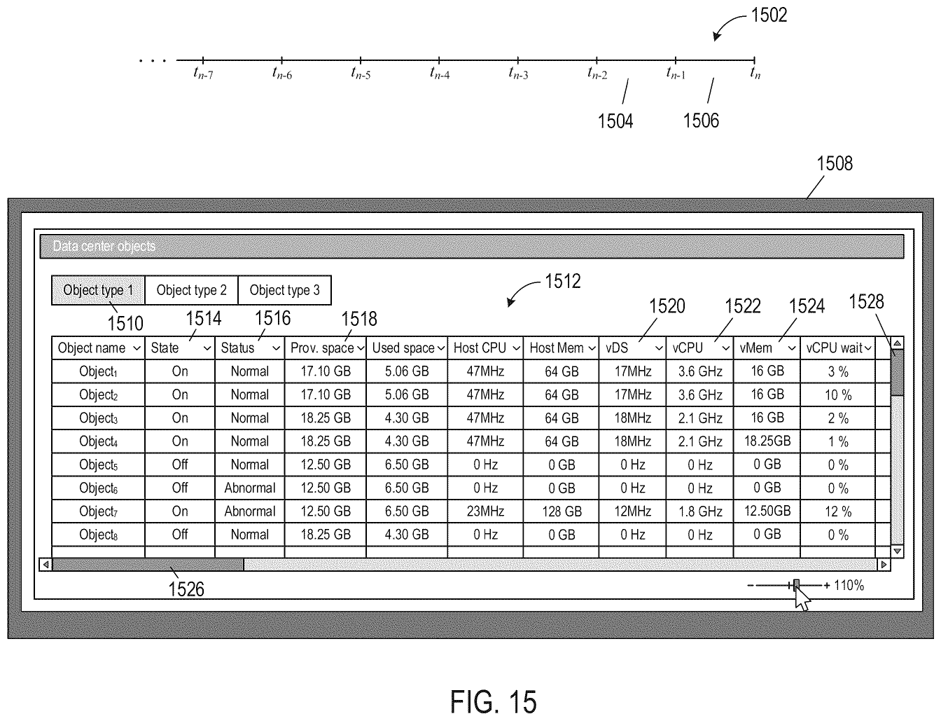

FIG. 15 shows an example of a timeline 1502 partitioned into time intervals denoted by (tₙ₋₁, tₙ], where tₙ₋₁ denotes the beginning of a time interval and to denotes the end of the time interval, such as time intervals 1504 and 1506. FIG. 15 also shows an example GUI 1508 that displays values of attributes of objects executing in a data center. The example GUI 1508 enables a user to select different types of objects identified object type 1, object type 2, and object type 3. For example, object type 1 can be the VMs executing in the data center, object type 2 can be containers executing in the data center, and object type 3 can be hosts executing in the data center. In this example, object type 1 has been selected as indicated by shaded button 1504. The GUI 1508 displays an attribute data table 1512 associated with the objects that are object type 1. The objects are identified as Objectₙ, where subscript n is an object index used to distinguish the objects belonging to the object type 1. The attributes associated with the objects include, but is not limited to, the on/offstate listed in column 1514, normal/abnormal state listed in column 1516, the storage space provisioned to each object listed in column 1518, virtual data storage listed in column 1520, virtual CPU usage listed in column 1522, and virtual memory listed in column 1524. The values of attributes are collected and displayed in the table 1512. For example, the attribute values displayed in the table 1512 may have been collected in the time interval 1504 and displayed at time tₙ₋₁. The attribute values in the table 1512 are updated at time tₙ with the attributes collected in the time interval 1506. The table 1512 includes scroll bars 1526 and 1528 that enable a system administrator to view different portions of the table 1512.

Ideally, a system administrator visually examines entries of an attribute data table to identify relative differences in attribute of the objects of a data center, such as CPU usage of a host that is much larger than the CPU usage of other hosts. This technique may be useful for a very small number of objects with few attributes. However, such tables are not practical when the number of attributes is large, as is the case with the multitude of objects typically running in a data center. Consider, for example, a data center running only one thousand VMs, where each VM has 15 attributes that are monitored in real time and attribute values are updated every five minutes in an attribute data table. The table will have 15,000 table entries to visually inspect for attribute values that are indicative of relative attribute changes. However, a system administrator can only view portions of the table at a time to try and spot anomalous attribute values out of an array of thousands of table entries. People often become bored, tired, and frustrated with inspecting data table entries even after short periods. The system administrator in this case will become overwhelmed with trying to identify in real time relative attribute differences for numerous objects from an array of thousands of attribute values, resulting in a high likelihood that significant changes in attribute values will be missed. As a result, the current practice of visually scanning tables for relative attribute changes that may reveal significant attribute changes is not practical, extremely tedious, time consuming, and error prone.

Attributes of objects may be subject to change over time. For example, server computers can be switched on or off and upgraded with an updated operating system or additional hardware components can added, such as the addition of additional ethernet cards, change in CPUs, or increase in memory. The configurations of VMs and containers may change over time. The operations manager 1330 periodically updates attribute values for each attribute in the attribute database 1332 for a current time interval (tₙ₋₁, tₙ]. The duration of the time interval is set by a user and may be, for example, as a short as one minute or as long 24 hours.

This disclosure is directed to automated methods that are executed in the operations manager 1330 of a data center to monitor attributes of objects executing in a data center and display object icons that visually represent the current states of the attributes of the objects in a GUI, thereby enabling system administrators or application owners to immediately detect relative differences in attributes of the objects by simply glancing at the object icons. The fundamental premise behind representing the status of objects as object icons that are familiar to human beings rather than traditional data tables is that human beings have an innate ability to visually distinguish between changes to different features of the object icons by briefly glancing at the object icons. In the following discussion of various implementations of the methods and systems, the objects are VMs, and the object icons used to represent attributes of the VMs are facial icons because human beings have an innate ability to at a glance distinguish between sizes of eyes, lengths of a nose, widths and shapes of mouths, extent of hair, and sizes of ears of numerous human faces. It should be noted that implementations described herein are not limited to using icons to represent attributes of VMs. The same icons can be used to represent attributes of other types of the objects, such as containers, pods, server computers, network devices, and other components of a data center.

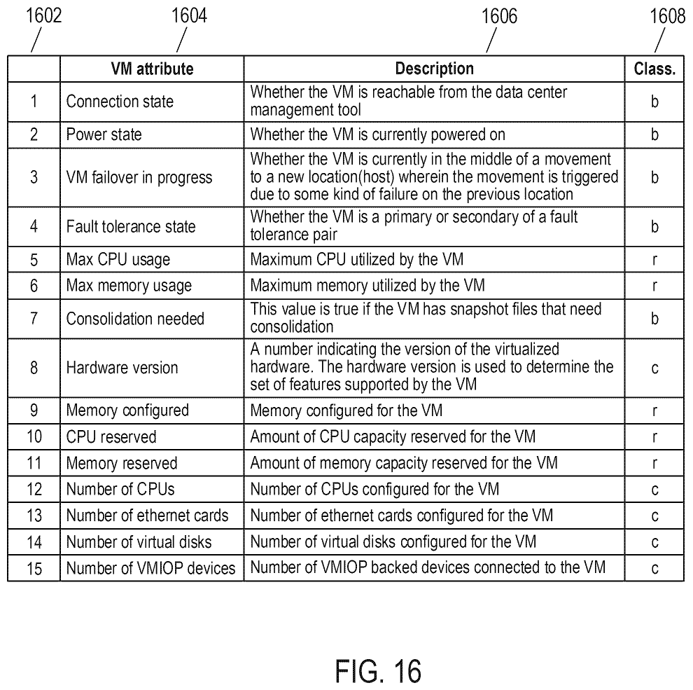

FIG. 16 shows a table of 15 example VM attributes that can be used to monitor VMs executing in a data center. Column 1602 is a list of 15 numerical indices that correspond to the 15 example VM attributes listed in column 1604. Entries in column 1606 contain corresponding descriptions of the VM attributes listed in column 1604. In column 1608, the attributes are tagged according to data type as binary (“b”), categorical (“c”), and continuous over a range of values (“r”). The “on” or “off” power state of an object is an example of a binary attribute that is represented as a binary numerical value, such as “0” representing an “off” power state and a “1” representing an “on” power state. The connection state of a VM is an example of a binary attribute that can be represented by binary values 0 and 1, where 0 represents the VM is not reachable from a data center management tool, and 1 represents the VM is reachable from the data center management tool. The hardware version, number of CPUs, number of ethernet cards, number of virtual disks, and number VMIOP devices are examples of categorical data, each attribute represents a quantity available to the VM. The maximum CPU usage, maximum memory usage, memory configured, and CPU reserved are examples of values that vary over continuous ranges.

It should be noted that methods and systems are not limited to the list of 15 attributes in FIG. 16. Attributes can be any measurable aspect of a data center object. In other implementation, the list of attributes may include any number of attributes associated with CPU usage, memory usage, number of datastores, disk usage, and network. For example, the additional attributes include CPU wait time. CPU contention. CPU reservation used, peak vCPU usage, memory contention, memory reservation used, datastore IOPS, outstanding IO requests, datastore demand, datastore latency, and throughput, just to name a few. The attributes may also include days since last operating system or other software updates, such as days since last antivirus update.

The operations manager 1330 maps values of object attributes to features of object icons that represent the objects. Each object attribute corresponds to a feature of an object icon and has a corresponding mapping that relates the current value of the attribute to the size and/or shape of the feature. The operations manager 1330 maps values of the attributes of the objects collected in a current time interval to sizes and shapes of features of the object icons.

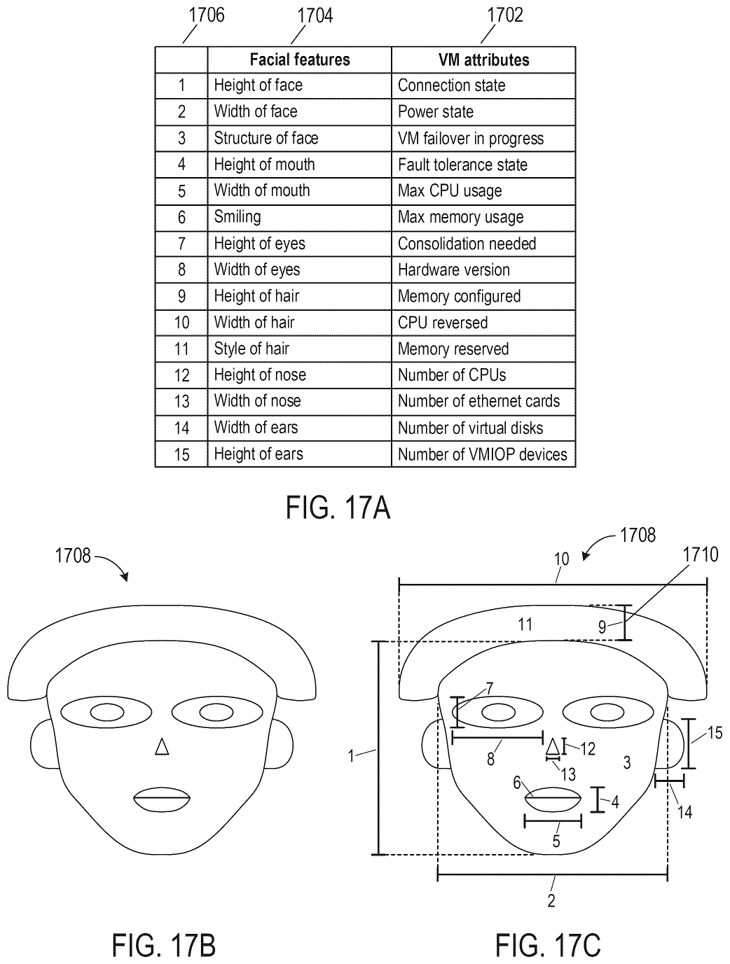

FIGS. 17A-17C show how facial features of a facial icon correspond to the 15 example VM attributes in FIG. 16. FIG. 17A shows a table of the 15 VM attributes of FIG. 16 listed in column 1702 and corresponding facial features listed in column 1704. Column 1706 lists the numerical indices of the VM attributes that also correspond to the facial features in column 1704. FIG. 17B shows an example of a facial icon 1708 that represents a VM. FIG. 17C shows how the numerical indices of the facial features listed in FIG. 17A correspond to dimension lines of facial features of the facial icon 1708. For example, in FIG. 17A, the amount of memory configured for the VM in column 1702 corresponds to “height of hair” in column 1704 and is represented by the numerical index 9 in column 1706. The height of hair of the facial icon 1708 is indicated in FIG. 17C by dimension line 1710 labeled with numerical index “9.” In other words, the amount of memory configured for the VM maps to the height of hair 1710 of the facial icon 1708.

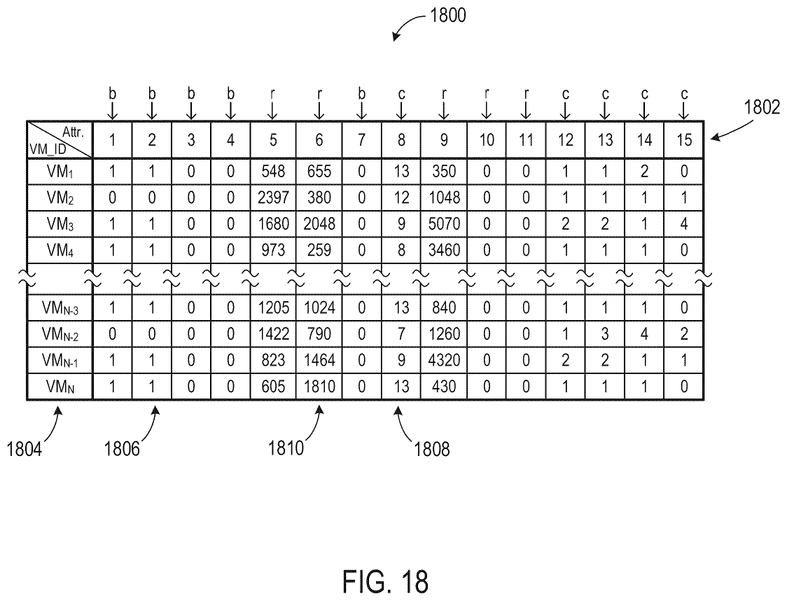

FIG. 18 shows an example table 1800 that list N VMs and corresponding attribute values of the 15 example attributes associated with the N VMs. The value N is a positive integer. The table 1800 is stored in an object/attribute database and is automatically updated by the operations manager 1330 with the most recent attribute values at the end of the current time interval as described above with reference 15. Row 1802 contains the 15 numerical indices in column 1706 of FIG. 17A, which represent the 15 example VM attributes listed in column 1702 of FIG. 17A. Column 1804 list the N VMs denoted by VM₁, . . . , VM_{N}. Each row contains attribute values of the 15 attributes of a VM collected by the operations manager 1330 in a current time interval. The columns contain the attribute values for each of the 15 example attributes of the N VMs. For example, column 1806 contains attribute values that represent the on/off “power state” for each of the N VMs. Column 1808 contains the attribute values that identify a current version of the virtualized hardware associated with each of the N VMs. Column 1810 contains the attribute values that represent the maximum CPU usage by each of the N VMs in the current time interval. Note that each of the columns includes a tag that indicates whether the attribute values in the columns are binary attributes (“b”), categorical attributes (“c”), and continuous over a range of attribute values (“r”).

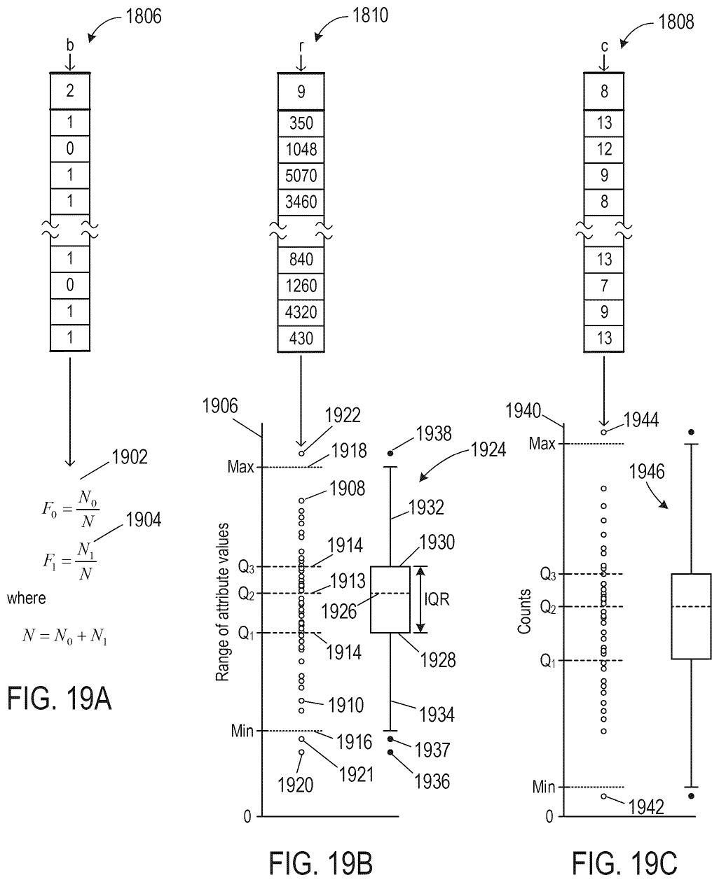

For each binary attribute, the operations manager 1330 computes a numeral, F₀, that represents the fraction of binary number 0's and a numeral. F₁, that represents the fraction of binary number 1's, where F₀+F₁=1. FIG. 19A shows an example of fractions computed for the binary attribute in column 1806. The binary values listed in column 1806 correspond to the on/off power state of the N VMs, where a number 0 corresponds to the “off” power state and 1 corresponds to the “on” power state. The operations manager 1330 computes a fraction F₀ 1902 of VMs in the “off” power state, where N₀ is the number of VMs in the “off” power state. The operations manager 1330 computes a fraction F₁ 1904 of VMs in the “on” power state, where N₁ is the number of VMs in the “on” power state.

For each attribute with attribute values in a continuous range of values, the operations manager 1330 partitions the distribution of attribute values into quartiles, where Q₂ denotes the median of all the values, Q₁ denotes a lower median of the values less than the median Q₂, and Q₃ denotes an upper median of the values greater than the median Q₂. The medians Q₁. Q₂, and Q₃ partition the range of attribute values into quartiles such that 25% of the values are greater than Q₃. 25% of the values are less than Q₁, 25% of the values lie between Q₁ and Q₂, and 25% of the values lies between Q₂ and Q₃. Fifty percent of the values lie in the interquartile range:

IQR=Q₃−Q₁ (1)

The interquartile range is used to compute a whisker minimum given by

Min=Q₁−B×IQR (2a)

and a whisker maximum given by

Max=Q₃+B×IQR (2b)

where B is a constant greater than 1 (e.g., B=1.5). The whisker minimum and the whisker maximum define a range of normal or acceptable attribute values for the attribute. An attribute value, v, that satisfies either of the following conditions is an outlier attribute value:

v≤Q₁−B×IQR (3a)

v≥Q₃+B×IQR (3b)

FIG. 19B shows an example of partitioning the values of the attribute values in column 1806 into quartiles and identification of outliers. Vertical line 1906 represents a range of attribute values for the attribute. Open dots, such as open dots 1908 and 1910, represent attribute values listed in column 1806 for the memory configuration attribute. Dashed horizontal lines 1912-1914 correspond to the values of the medians Q₁, Q₂, and Q₃. Dotted horizontal lines 1916 and 1918 correspond to the whisker minimum and whisker maximum computed according to Equations (2a) and (2b). In this example, open dots 1920-1922 are outliers. FIG. 19B includes a boxplot 1924 that represents the spread, or distribution, of attribute values in the quartiles and outliers. Dashed line 1926 corresponds to the median Q₂. Sides 1928 and 1930 of the box correspond to lower median Q₁ and upper median Q₃. Lengths of whiskers 1932 and 1934 correspond to the whisker maximum and whisker minimum values that define the limits of the normal range of attribute values for the attribute. Shaded dots 1936-1938 correspond to the outliers 1920-1922.

For each categorical attribute, the operations manager 1330 computes a count of the number of attributes values in each category of the attribute denoted by m₁, m₂, . . . m_{C}, where positive integer subscripts distinguish the different categories associated with the attribute, and C is the number of categories of the categorical attribute. For example, m₂ is the number of times category 2 attribute appeared in the current time interval. The operations manager 1330 partitions the distribution of values into quartiles and identifies outliers as described above with reference to Equations (1)-(3b).

FIG. 19C shows an example of partitioning the counts of the categories of the attribute in column 1808 into quartiles and identification of outliers. Vertical line 1940 represents a range of counts. Open dots represent counts of the categories listed in column 1808 for the hardware version attribute. For example, column 1808 reveals there at least three VMs with hardware version 13, which is represented by one of the open dots. In this example, open dots 1942 and 1944 are outliers. Boxplot 1946 represents the spread of attribute values over the quartiles and the outliers.

Each facial icon displayed in a GUI is composed of a number of pixels. A pixel is an area of illumination in an electronic visual display device, such as a monitor, tablet computer, or a mobile phone. Each pixel is a sample of an image, where increasing number of pixels provide a more accurate representation of the image. The intensity of each pixel is variable. In black and white imaging, each pixel is displayed as a shade of gray that ranges from white to black. In color imagine, each pixel is displayed as a color represented by three or four component intensities such as red, green, and blue, or cyan, magenta, yellow, and black. The operations manager 1330 maps the attributes values of certain attributes to numbers of pixels that define dimensions of corresponding object features of an object icon. A pixel dimension is the horizontal or vertical measurement in number of pixels of an electronic visual display device. In other words, the operations manager 1330 maps the attribute values to pixel dimensions in units of number of pixels in the electronic visual display device.

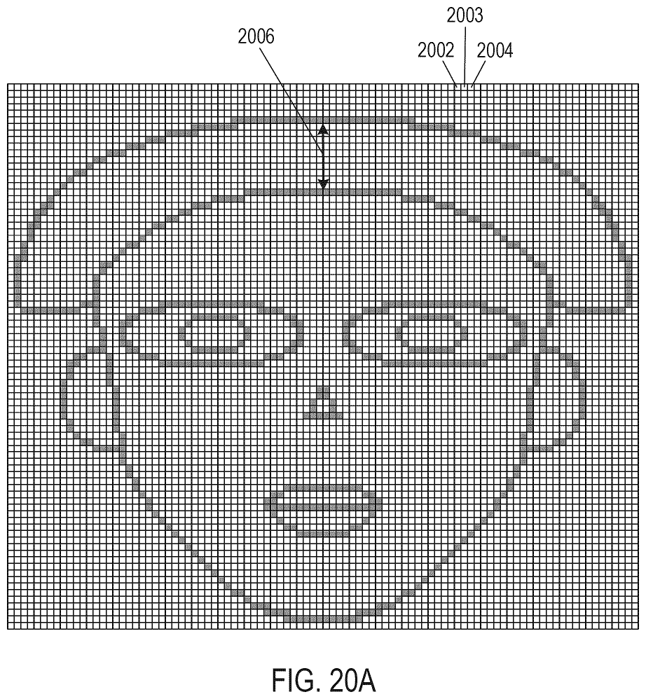

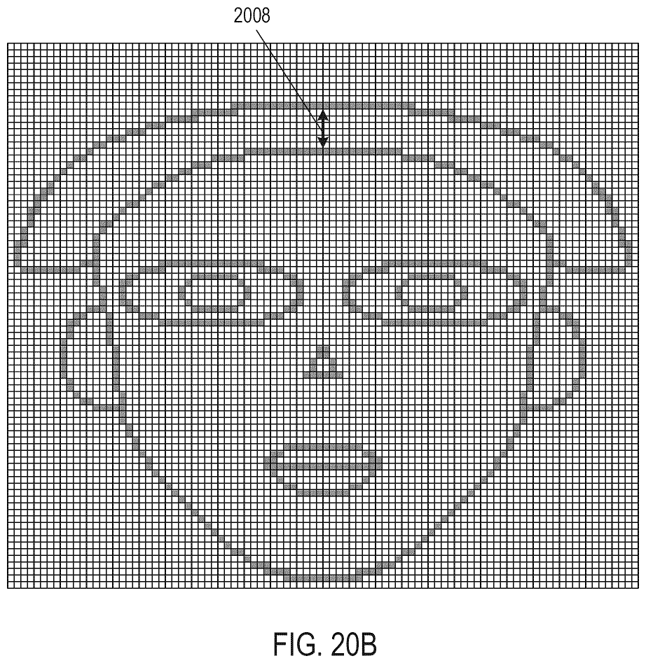

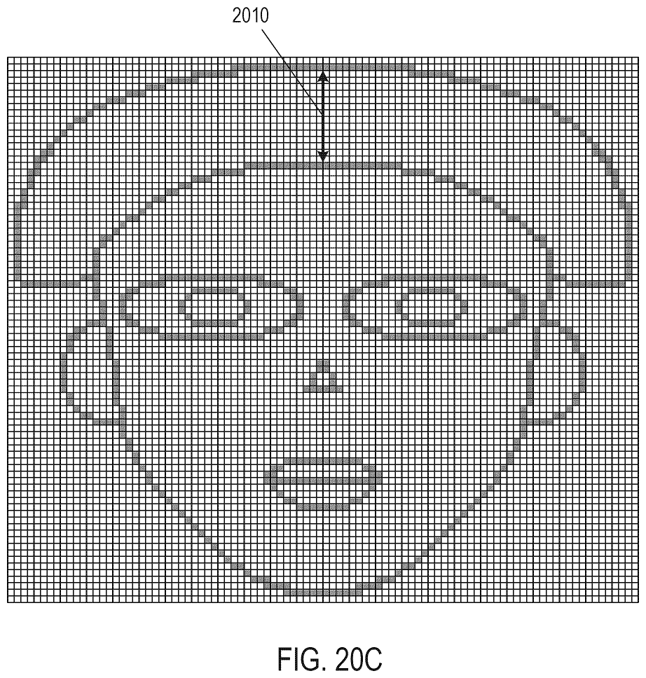

FIGS. 20A-20C show examples of how the number of pixels (i.e., pixel dimensions) that correspond to the feature of height of hair of three facial icons correspond to three different attribute values associated with three different VMs. In FIGS. 20A-20C, pixels are represented by squares. For example, in FIG. 20A, squares 2002-2004 represents three adjacent pixels of an electronic visual display device. The features of the facial icon are outlined with dark shaded pixels. In FIG. 17A, the VM attribute amount of memory configured for a VM maps to height of hair of the facial icon. In FIG. 20A, a first attribute value of the amount of memory configured for a first VM maps to the height of hair represented by directional arrow 2006, which indicates the height of hair has a pixel dimension of 12 pixels. In FIG. 20B, a second attribute value of the amount of memory configured for a second VM maps to the height of hair represented by directional arrow 2008, which indicates the height of hair has a pixel dimension of 8 pixels. In FIG. 20C, a third attribute value of the amount of memory configured for a third VM maps to the height of hair represented by directional arrow 2010, which indicates the height of hair has a pixel dimension of 16 pixels.

For binary attributes, the operations manager 1330 maps the binary value, b, of a binary attribute to a corresponding length dimension in pixels, or pixel dimension, of a feature of an object icon. The operations manager 1330 then adjusts the lengths of the features of the object icon according to the pixel dimensions. The operations manager 1330 assigns a value F to the value of the fraction associated with the binary value b as follows:

$$F = \{ \begin{matrix}{F}_{0} & if b = 0 \\ {F}_{1} & if b = 1\end{matrix} \qquad ( 4 a )$$

where F₀ and F₁ have been computed as described above with reference to FIG. 19A. Given the value F. the operations manager 1330 computes the pixel dimension of the feature associated with the attribute as follows:

p=F(pₘₐₓ−pₘᵢₙ)+pₘᵢₙ (4b)
where
   pₘᵢₙ≤p≤pₘₐₓ:
   pₘᵢₙ≤p≤pₘₐₓ is a maximum pixel dimension of the feature of the object icon; and
   pₘᵢₙ is a minimum pixel dimension of the feature of the object icon.

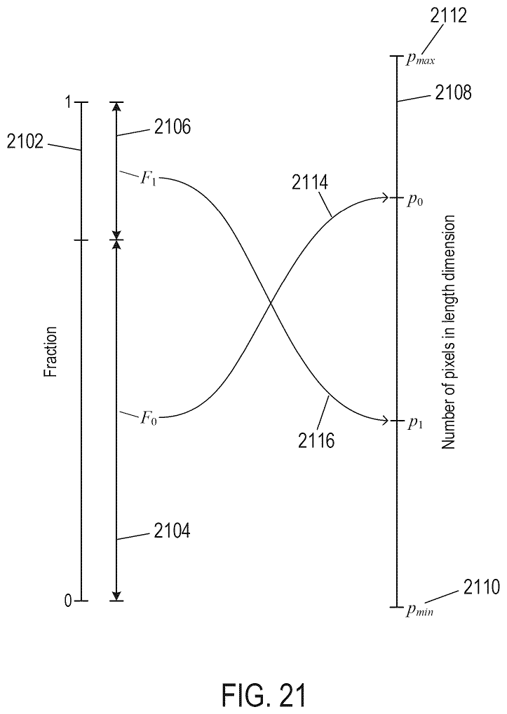

FIG. 21 shows an example of mapping fractions F₀ and F₁ to corresponding pixel dimensions. Axis 2102 represents a range of values for the fraction values associated with a binary attribute. Directional arrow 2104 represents F₀ for a binary value “0” of the binary attribute. Directional arrow 2106 represents F₁ for a binary value “1” of the binary attribute. Axis 2108 represents a range of pixel dimensions between a minimum pixel dimension 2110 and a maximum pixel dimension 2112. When the binary value of a VM is b=0. the operations manager 1330 maps the fraction F₀ to the pixel dimension p₀ according to Equations (4a) and (4b), as represented by directional arrow 2114. When the binary value of a VM is b=1, the operations manager 1330 maps the fraction F₁ to the pixel dimension p₁ according to Equations (4a) and (4b), as represented by directional arrow 2116.

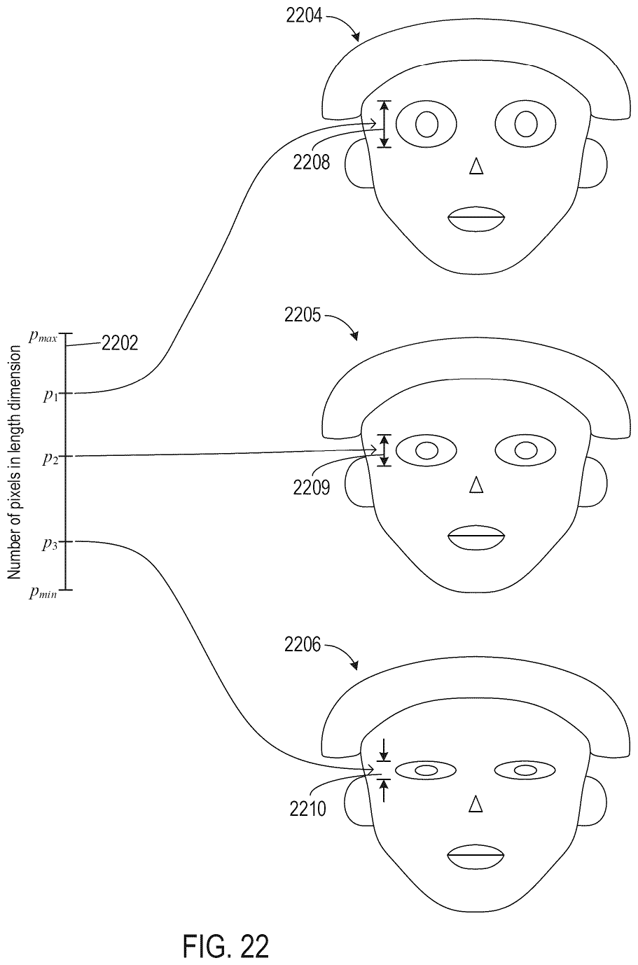

FIG. 22 shows examples of pixel dimensions and corresponding heights of eyes of facial icons. Axis 2202 represents a range of pixel dimensions. In FIG. 17A, heights of eyes correspond to a VM that has snapshot files in need of consolidation. FIG. 22 shows how the height of eyes is adjusted for different pixel dimensions of three facial icons 2204-2206 that represent three VMs. The difference between height of eyes reveals the relative difference between the three VMs. Large pixel dimension p₁ corresponds to a large height of eyes pixel dimension 2208. Moderate pixel dimension p₂ corresponds to a moderate height of eyes pixel dimension 2206. Small pixel dimension p₃ corresponds to a small height of eyes pixel dimension 2208. The height of eyes are visual indications to a viewer as to whether the snapshot files of the corresponding VMs should be consolidated. Large height of eyes 2208 may be a strong indication that snapshot flies of the VM are relatively larger than the snapshot files of other VMs and needs to be consolidated. Moderate height of eyes 2209 may be an indication that consolidation of the snapshot files of the VM is optional. Small height of eyes 2210 may be an indication that consolidation of the snapshot files of the VM are smaller or fewer than the other VMs and consolidation is not needed.

For categorical or continuous range attributes, the operations manager 1330 maps attribute value, v. to pixel dimensions in pixel-dimension intervals of a range of pixel dimensions as follows:

$$p = \frac{( v - {R}_{s} )}{( {R}_{t} - {R}_{s} )} ( {p}_{i} - {p}_{i - 1} ) + {p}_{i} \qquad ( 5 )$$

where
   Rₛ≤v<Rₜ; and
   pᵢ₋₁≤p<pᵢ.

The values Rₛ and Rₜ represent endpoints attribute value ranges defined by 0. Min. Q₁, Q₂, Q₃-Max, and Q₁ of the distribution of attribute values of the attribute (e.g., Rₛ=Q₁ and Rₜ=Q₂). The pixel dimensions pₗ₋₁ and pᵢ represent endpoints of a pixel-dimension interval, where i=1, . . . , 6.

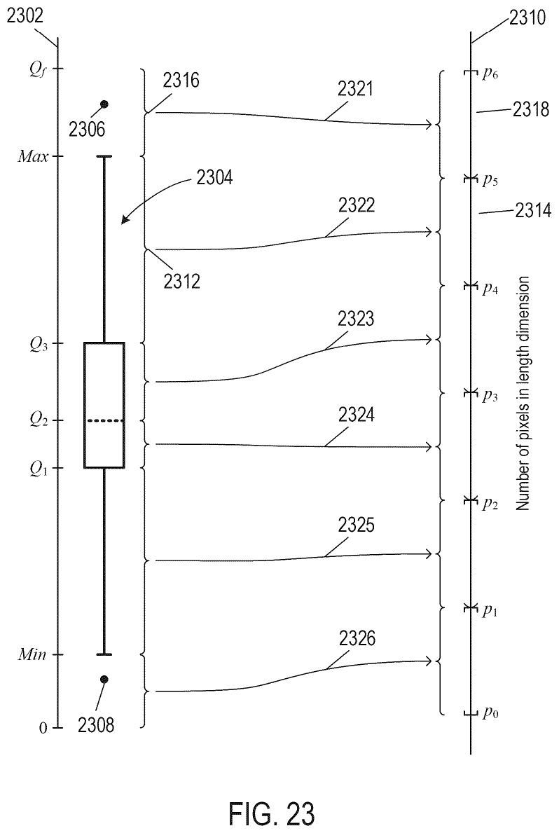

FIG. 23 shows an example of how attribute values map to pixel dimensions. Axis 2302 represents a range of attribute values. FIG. 23 includes a boxplot 2304 with outliers 2306 and 2308 that represents a distribution of attribute values of an attribute. The attributes values can be obtained for a categorical attribute as described above with reference to FIG. 19C, or the attribute values can be obtained for a continuous range attribute as described above with reference FIG. 19B. Axis 2310 represents a range of pixel dimensions. The range of pixel dimensions has been partitioned into six pixel-dimension intervals that correspond to the four quartiles and outlier intervals. For example, quartile 2312 corresponds pixel-dimension interval 2314 and outlier interval 2316 corresponds to pixel-dimension interval 2318. Directional arrows 2311-2316 representing mapping attribute values in quartile and outlier intervals to corresponding pixel-dimension intervals according to Equation (5).

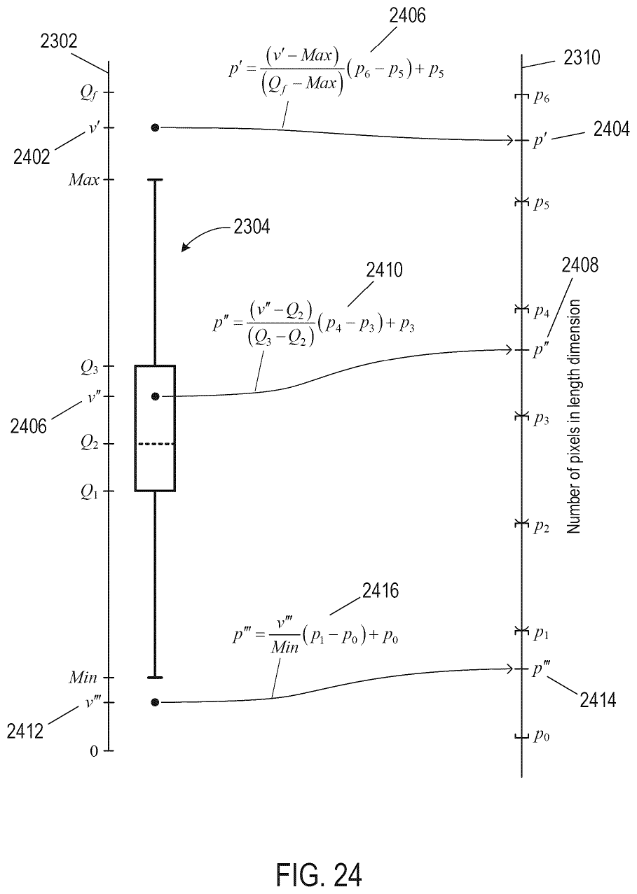

FIG. 24 shows examples of attribute values mapped to pixel dimensions in accordance with the mapping in Equation (5). Outlier attribute value v′ 2402 is mapped to pixel dimension p′ 2404 according to mapping 2406. Outlier attribute value v″2406 is mapped to pixel dimension p″ 2408 according to mapping 2410. Outlier attribute value v″′ 2412 is mapped to pixel dimension p″′ 2414 according to mapping 2416.

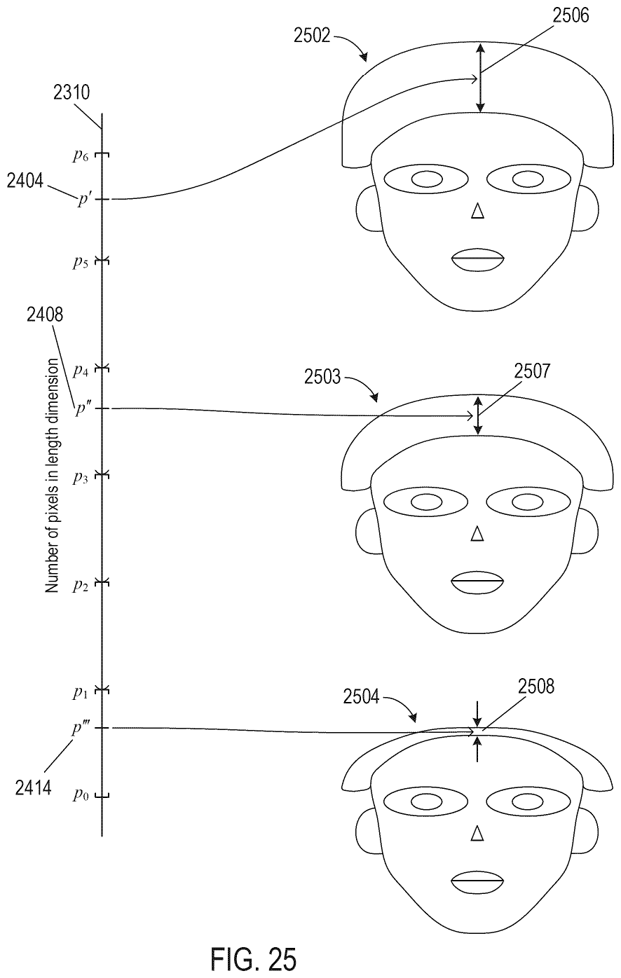

Suppose, for example, the boxplot 2304 in FIG. 23 represents the distribution of memory configured for the VMs. FIG. 25 shows examples of pixel dimensions and corresponding heights of hair of three facial icons 2502-2504 that represent three VMs. The large pixel dimension p′ 2404 corresponds to a large height of hair pixel dimension 2506. The moderate pixel dimension p″ 2408 corresponds to a moderate height of hair pixel dimension 2507. The small pixel dimension p″′ 2414 corresponds to a small height of hair pixel dimension 2508. The height of hair is a visual indication to a viewer of the relative amount of memory configured for the three VMs. Large height of hair 2506 indicates that the corresponding VM has a relatively larger amount of memory compared to the other MVs. Moderate height of hair 2507 indicates that the corresponding VM has an amount that is consistent with the other VMs. Small height of eyes 2508 indicates that the corresponding VM has a relatively smaller amount of memory compared to the other VMs.

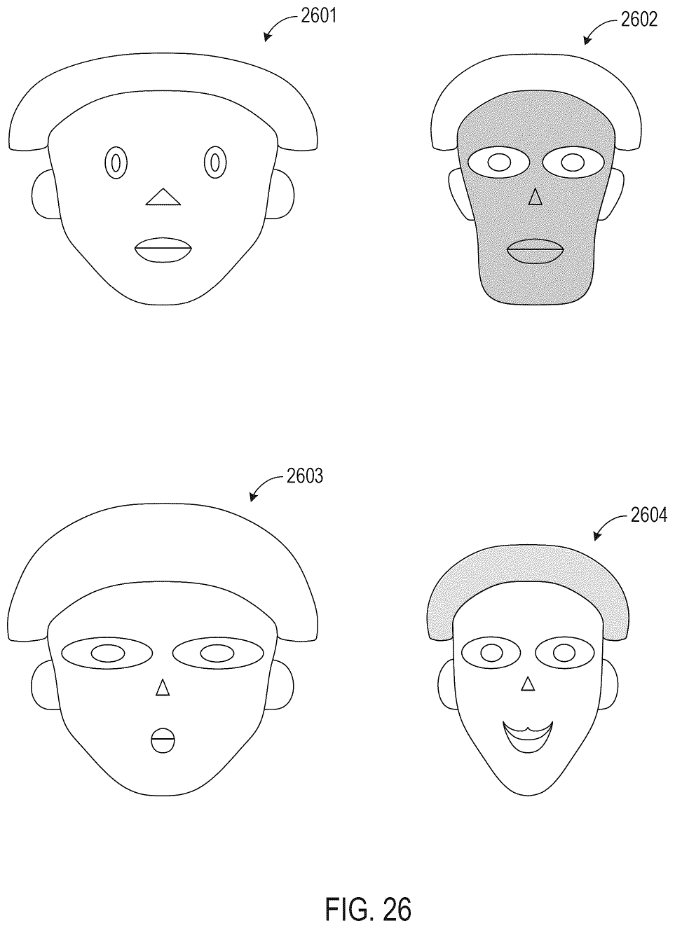

The operations manager 1330 maps the attribute values for each of the objects to features of icons based on the binary mapping in Equations (4a) and (4b) and Equation (5). FIG. 26 show examples of facial icons 2601-2604 with different facial features that represent different states of attributes of four VMs with reference to FIG. 17A. For example, facial icons 2601 and 2503 have wider faces than facial icons 2602 and 2604, which can be used as an indication that the VMs represented by facial icons 2601 and 2603 are powered “on” and the VMs represented by facial icons 2602 and 2604 are powered “off.” Size of features are indications of the relative sizes of attributes values of the VMs represented by the facial icons. For example, width of eyes 2606 indicates that the hardware version used to execute the VM represented b) facial icon 2603 is different from the hardware version used to execute the VM represented by facial icon 2601. Facial icon 2602 has a different shape of face than facial icons 2601, 2603, and 2604, which is an indication that the VM represented by facial icon 2602 is in the process of being moved to a new host server computer and the movement has been triggered by a failure at the previous host server computer.

Object attributes are not limited to changes in the pixel dimensions, pixel widths, and shapes of features of the object icons. Changes in color or shading of pixels can also be used to indicate relative differences between attributes of the objects. For example, in FIG. 26, the face of facial icon 2602 is shaded to correspond to an attribute value of an attribute of the VM represented by the facial icon 2602. Hair of facial icon 2604 is also shaded to correspond to an attributed value of an attribute of the VM represented by the facial icon 2604.

The operations manager 1330 maps attribute values of binary, categorical, and continuous range attributes of hosts and containers running in the data center to pixel dimensions icons, as described above with reference to Equations (4a)-(4b) and (5), and as described above with reference to FIGS. 21-26. The operations manager 1330 displays object icons with features that represent the relative attribute values of the user selected objects, such as VMs, hosts, and containers, in a GUI for a current time interval.

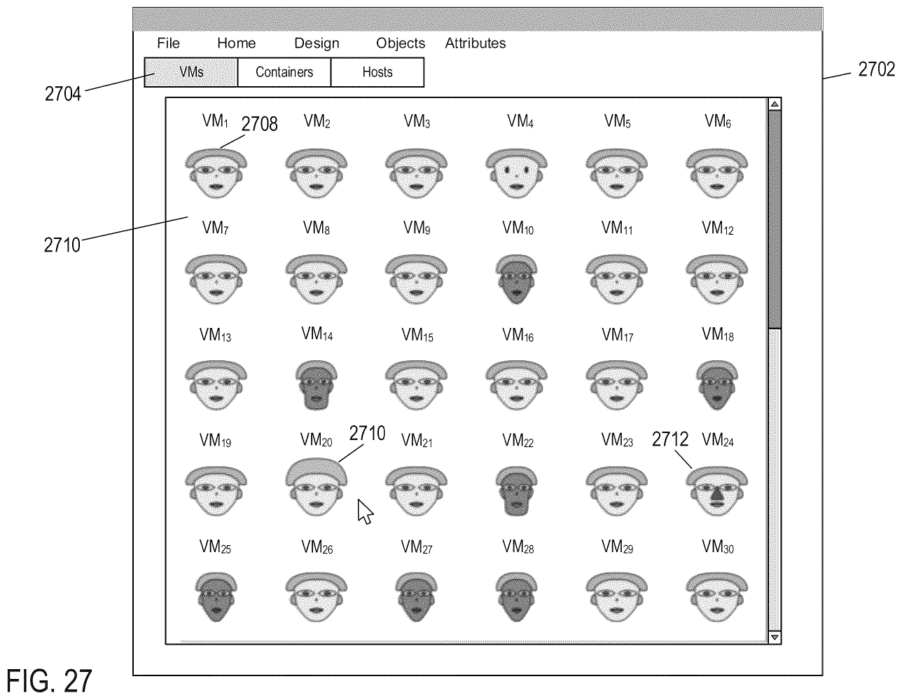

FIG. 27 shows an example of a GUI 2702 that displays facial icons of the VMs running in a data center. In this example, a user has selected VMs as indicated by shaded button 2704. Field 2706 displays a facial icon for each VM running in the data center. Each VM is represented by a facial icon that reveals the relative state of attributes of the VM and includes the name of the VM. For example, VM₁ is represented by facial icon 2708. Note that many of the facial icons are identical, which indicates the corresponding VMs are in the same relative performance state. For example, a viewer can observe at a glance that the facial icons of VM₁, VM₂, VM₃, VM₅, and VM₆ are in the same relative performance state. By contrast, the same viewer can immediately recognize that the eyes of the facial icon of VM₄ are abnormally narrower than the eyes of the other facial icons displayed, which indicates that there is a relative difference in the hardware version attribute of VM₄ as compared to the other VMs displayed. A viewer can observe at a glance that the width of the facial icons for VM₁₀. VM₁₄, VM₁₈. VM₂₂. VM₂₅, VM₂₇, and VM₂₈ are narrower than the other facial icons displayed, which indicates VM₁₀, VM₁₄, VM₁₈. VM₂₂. VM₂₅, VM₂₇, and VM₂₈ are in a different power state than the other VMs. A viewer can observe at a glance that the height of hair of the facial icon 2710 of VM₂₄ is larger than the other VMs, which indicates VM₂₄ has a different memory configuration than the other VMs. A viewer can observe at a glance that the width of nose of the facial icon 2712 of VM₂₄ is larger than the other VMs, which indicates VM₂₄ has a different number of ethernet cards than the other VMs.

A user can hover the cursor over a facial icon and view the list of attributes and the associated attributes values in a pop-up window for the current time interval. The operations manager 1330 highlights, or identifies, the outlier attribute values so that the viewer can at a glance identify the outlier attribute values.

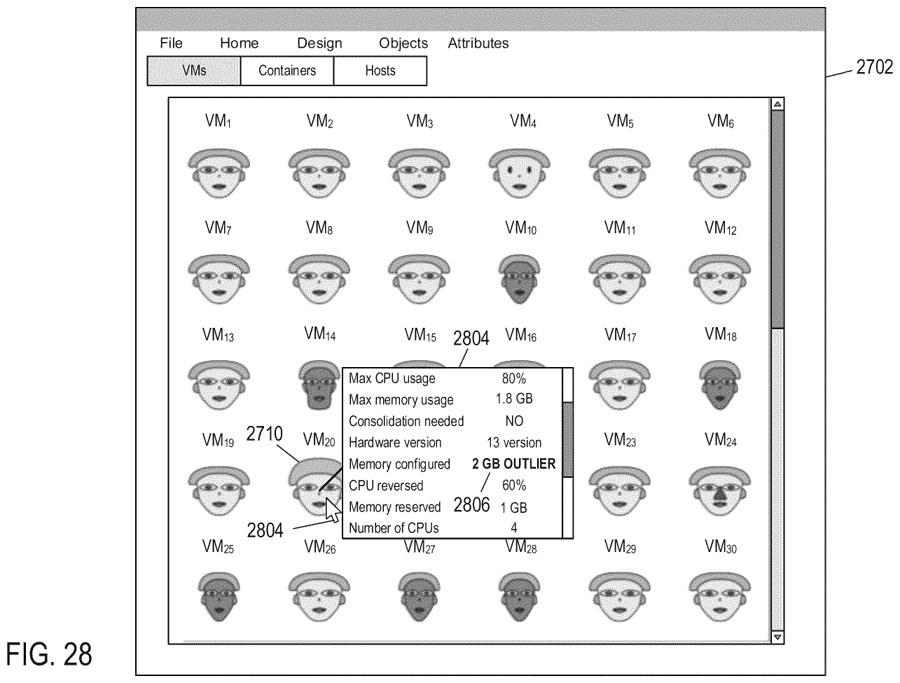

FIG. 28 shows an example of the cursor 2802 placed over the facial icon 2710. Hovering the cursor over the facial icon 2710 triggers creation of a pop-up window 2804 that displays a table of the attributes and current attribute values of VM₂₀. The outlier attribute value 2806 associated with the height of hair is highlighted in the pop-up window and, in this example, is explicitly identified as an “outlier.”

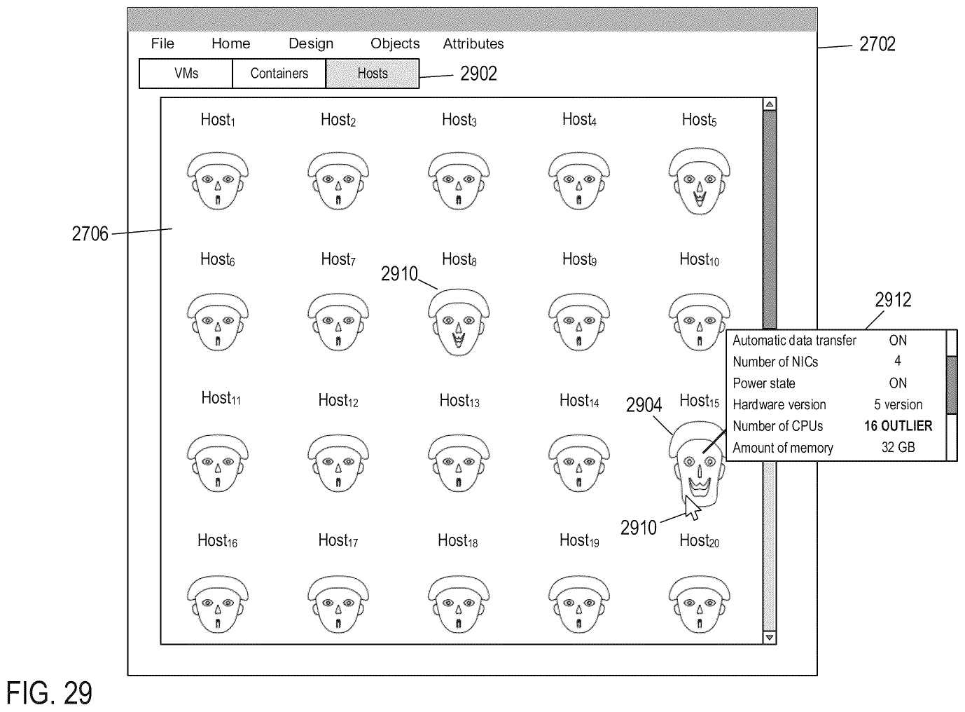

FIG. 29 shows an example of the GUI 2702 used to display facial icons of the hosts running in the data center. In this example, the user has selected hosts as indicated by shaded button 2902. The facial icons displayed in the field 2706 represent the attributes of the host running in the data center. The operations manager 1330 maps the number of CPUs a host is configured with to the height of face of the facial icons. A cursory glance at the GUI 2702 shows that the heights of the facial icons 2904, 2906, and 2908 are larger than the heights of the other 17 facial icons displayed with the height of facial icon 2904 much larger than the facial icons 2906 and 2908. The user can hover the cursor over each facial icon to create a pop-up window that displays the attributes and current attribute values of each host, as described above with reference to FIG. 28. For example, in FIG. 29, hovering the cursor 2910 over the facial icon 2904 creates a pop-up window 2912 that reveals Host₁₅ is configured with 16 CPUs, which is identified as an “outlier” with respect to the other hosts. Hovering the cursor over facial icons 2906 and 2908 creates separate similar pop-up windows that reveal Host₅ and Host₈ are each configured with 8 CPUs. Hovering the cursor over each of the other remaining 17 facial icons reveals that each of these hosts are each configured with 4 CPUs.

The operations manager 1330 collects and maintains a record of attribute values of group attributes of a set of data center objects over time. The attribute values are used to track changes in group attributes of the set of objects in consecutive time periods. The duration of the time periods is set be a user. For example, the duration of the time periods can be every 6 hours, every 12 hours, or every 24 hours. The operations manager 1330 displays an object icon that represents the group attributes of multiple objects in the GUI based on attribute values collected in each time period. The operations manager 1330 maps attribute values of the group attributes of the multiple objects to pixel dimensions of object icons as described above with Equation (5) and FIGS. 23-25.

The multiple objects can be objects of a software defined data center (“SDDC”) executing in the data center, such as the VMs and server computers that form the SDDC. The multiple objects can be objects that form a virtual network of the data center. The multiple objects can be composed of only the VMs running in the data center. The multiple objects can be composed of the hosts running in the data center. The multiple objects can be composed of the containers running in the data center.

FIG. 30 shows a table of example group attributes and corresponding facial features of facial icons that represent multiple objects of an SDDC. The facial features of the facial icons are listed in column 3002. The group attributes that correspond to the facial features are listed in column 3004. Column 3006 lists the numerical indices that correspond to the six attributes and the facial features in column 2004.

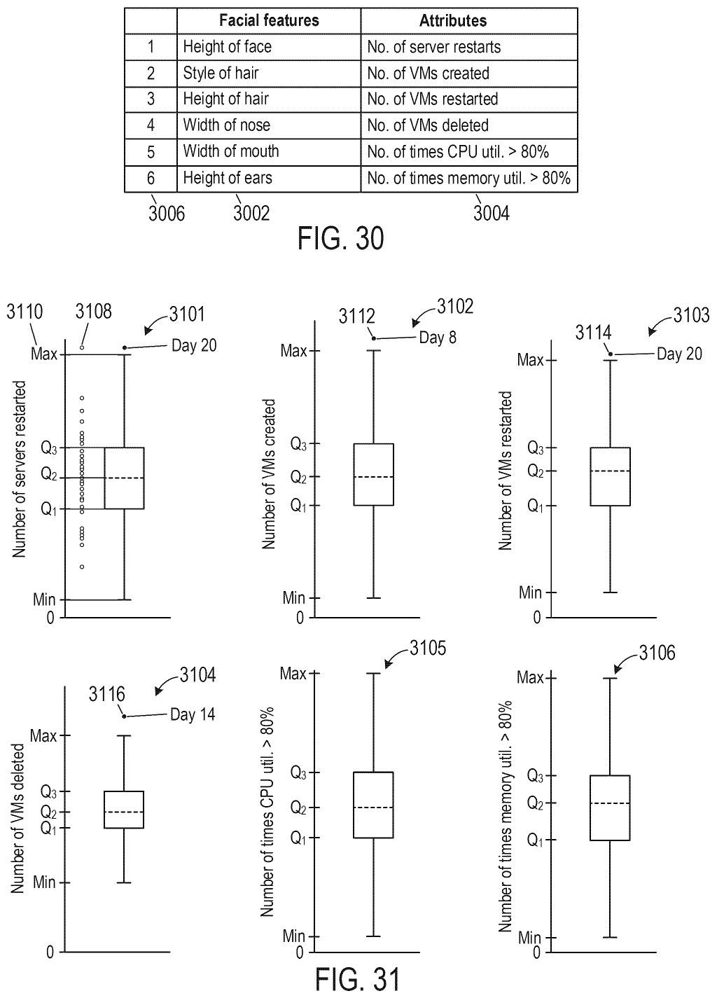

FIG. 31 shows six example boxplots 3101-3106 of distributions of attribute values for the six group attributes listed in column 3004 of FIG. 30. Each boxplot represents a distribution of attribute values collected each day for 30 days. Each attribute value represents the attribute for one day, or a 24-hour period. Boxplot 3101 includes open dots that represent the number of servers restarted each day of the 30 days. Each open dots represents the number of servers restarted in one day of the 30 days. For example, open dot 3108, which exceeds the maximum 3110, represents the number of servers restarted on day 20 and is an outlier. Boxplots 3102, 3103, and 3105 also have outliers identified by shaded dots 3112, 3114, and 3116, respectively.

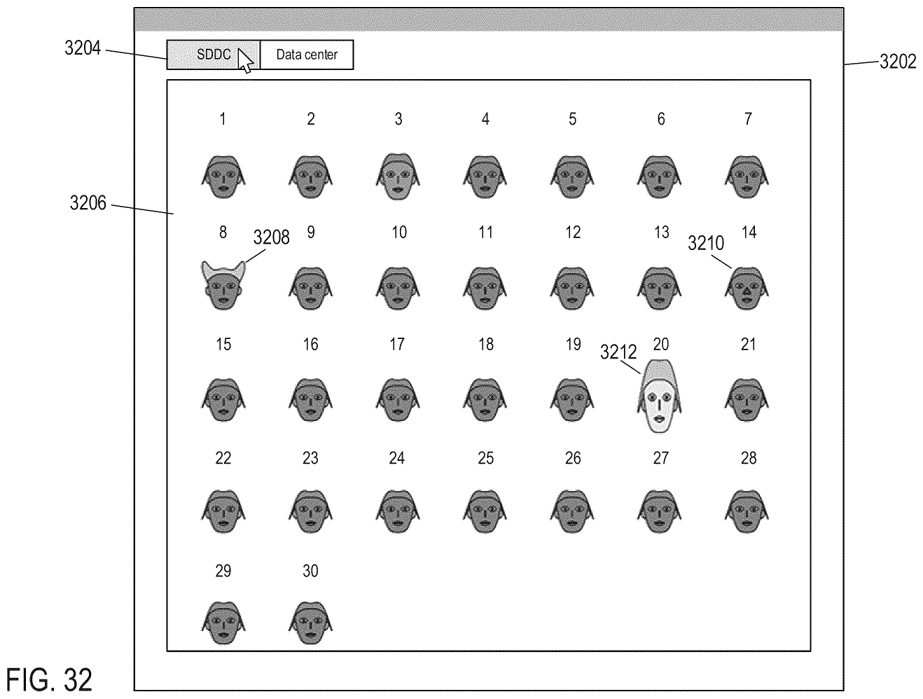

FIG. 32 shows an example of a GUI 3202 that displays facial icons that represent group attributes of objects that form an SDDC. In this example, the user has selected SDDC as indicated by shaded button 3204. The facial icons displayed in the field 3206 represent the group attributes of the object of the SDDC. Each facial icon represents attribute values of the group attributes collected for one day of the 30 days. The operations manager 1330 maps the attribute values obtained in one day to features of a facial icon that represents the day as described above with reference to Equation (5). For example, each of the attribute values represented by open dots in the boxplot 3101 is mapped to the pixel dimension of the height of face feature of the 30 facial icons. A cursory glance at the facial icons in the GUI 3202 reveals that facial icons 3208, 3210, and 3212 are different from the other 27 facial icons. In other words, facial icons 3208, 3210, and 3212 reveal at a glance relative change in the group attributes of the SDDC on days 8, 14, and 20. The style of hair change in facial icon 3208 resulted from the creation of 10 VMs on day 8. The width of nose change in facial icon 3210 resulted from a large deletion of VMs on day 14, which may correspond to deletion of the 10 VMs created on preceding day 8. Facial icon 3212 shows an increase in the height of hair and an increase in the height of face, which correspond to changes in the relative number of VM restarts and changes in the relative number of server restarts, respectively.

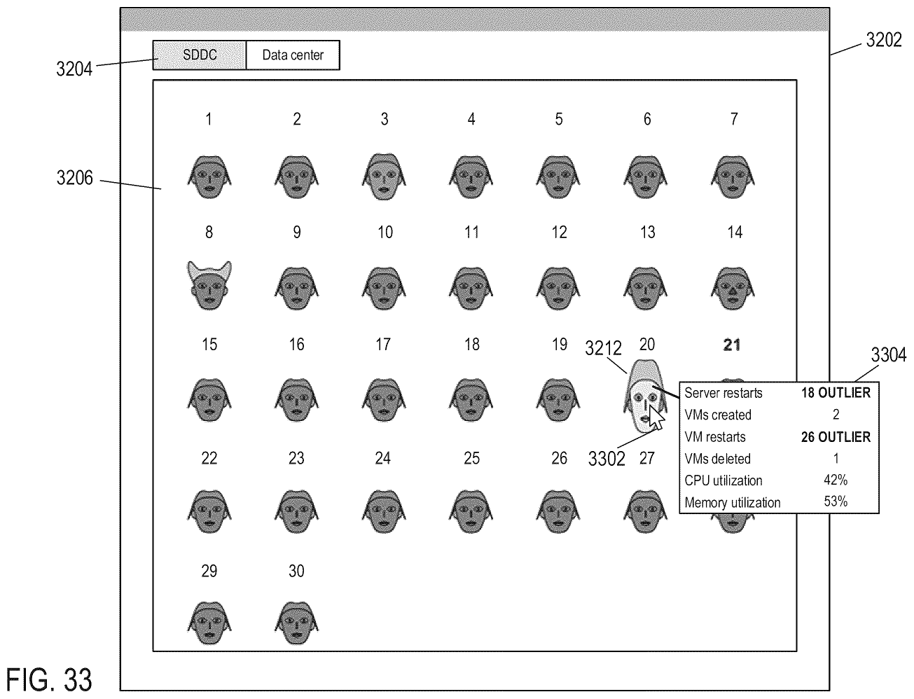

The user can hover the cursor over each facial icon to create a pop-up window that displays the group attributes and attribute values obtained for each day. FIG. 33 shows an example of hovering the cursor 3302 over the facial icon 3212 to create a pop-up window 3304 that reveals obtain for day 20. Pop-up window 3304 shows attribute values obtained for each of the group attributes listed in column 3004 of FIG. 30 on day 20. The number of server restarts is 18, which is identified as an outlier, and the number of VM restarts is 26, which is identified as an outlier.

Implementations are not limited using facial icons to represent relative differences in attributes of data center objects or represent relative changes in group attributes of multiple objects running in a data center over time. In other implementations, operations manager 1330 allows a user to select different object icons to represent attributes.

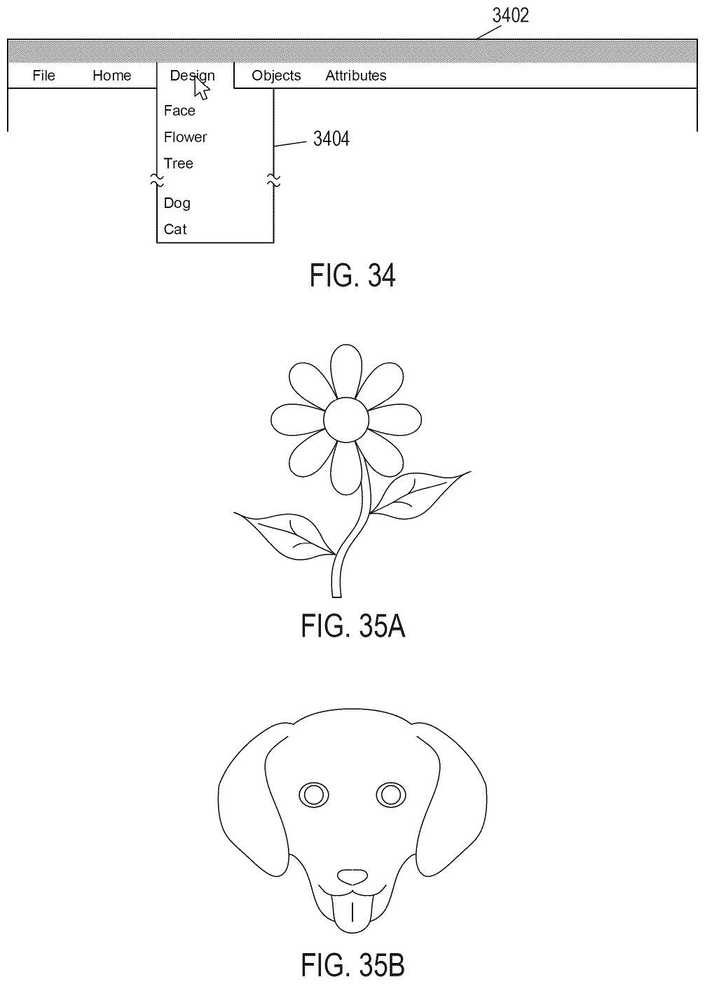

FIG. 34 shows an example GUI 3402 may present a drop-down menu 3404 that enables a user to select a particular type of object icon to represent attributes of objects running in a data center. The object icons are of objects that human beings have an innate ability to visually distinguish between changes to different features of the object icons by briefly glancing at the object icons. For example, the object icons can be of plants, such as flowers and trees, or the object items can be of different varieties of pets, such as dogs, cats, and birds.

FIG. 35A shows an example of a flower icon that can be used to represent various attributes. The features include petals, leaves, and a stem which can be varied in terms of length, width, and color to represent corresponding relative differences in attribute values as described above.

FIG. 35B shows an example of a dog face icon that can be used to represent various attributes. The features include face, ears, and tongue which can be varied in terms of length, width, and color to represent corresponding relative differences in attribute values as described above.

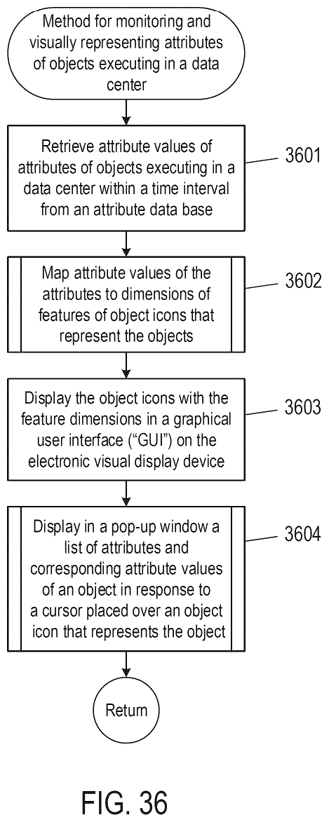

The methods described below with reference to FIGS. 36-40 are stored in one or more data-storage devices as machine-readable instructions and are executed by one or more processors of a computer system, such as the computer system shown in FIG. 1.

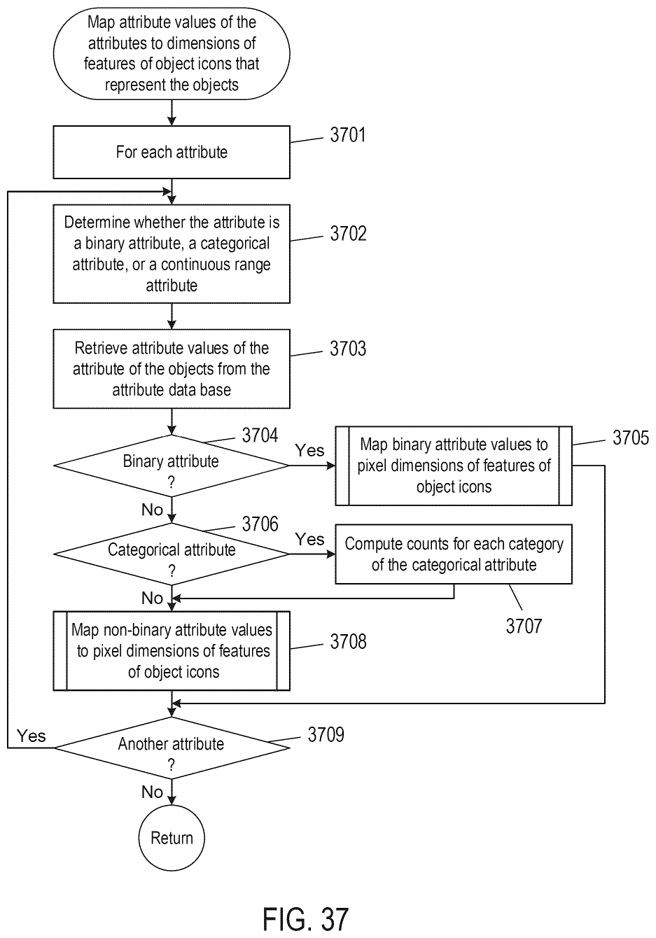

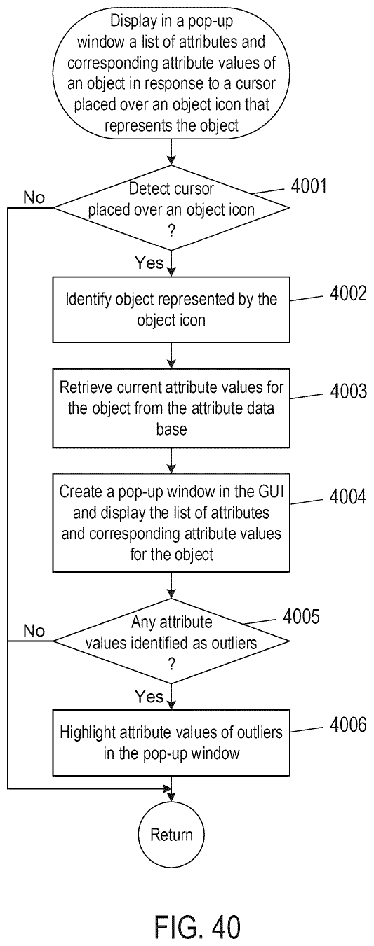

FIG. 36 is a flow diagram of a method for monitoring and visually representing attributes of objects executing in a data center. In block 3601, attribute values of attributes of objects executing in a data center within a time interval are retrieved from an attribute database. In block 3602, a “map attribute values of attributes to dimensions of features of object icons that represent the objects” procedure is performed. An example implementation of the “map attribute values of attributes to dimensions of features of object icons that represent the objects” is described below with reference to FIG. 37. In block 3603, the object icons with the feature dimensions are displayed in a GUI on the electronic visual display device. In block 3604, a “display in a pop-up window a list of attributes and corresponding attribute values of an object in response to a cursor placed over an object icon that represents the object” procedure is performed. An example implementation of the “display in a pop-up window a list of attributes and corresponding attribute values of an object in response to a cursor placed over an object icon that represents the object” is described below with reference to FIG. 40.

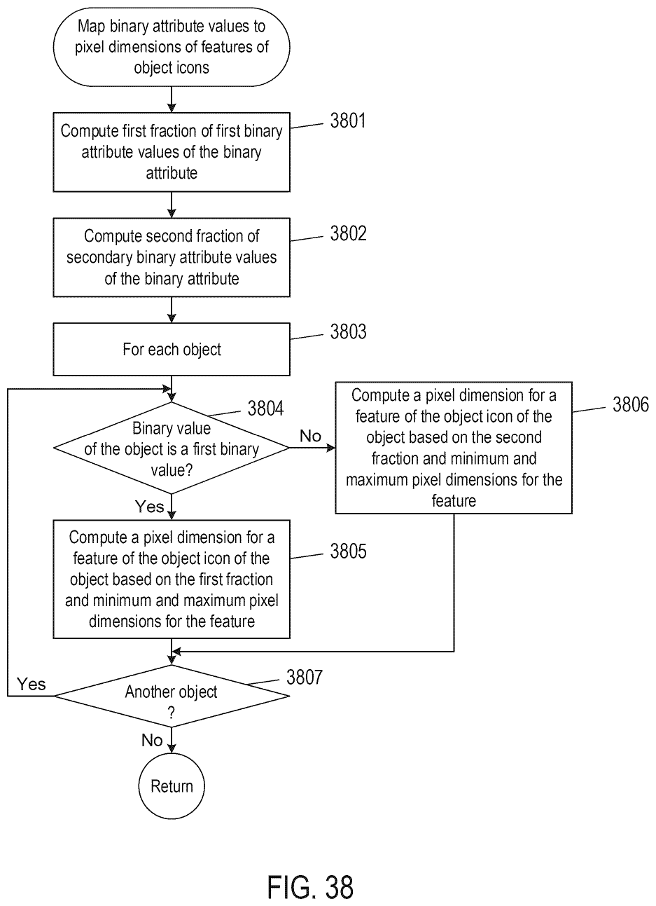

FIG. 37 is a flow diagram illustrating an example implementation of the “map attribute values of attributes to dimensions of features of object icons that represent the objects” procedure performed in block 3602 of FIG. 36. A loop beginning with block 3701 repeats the computational operations represented by blocks 3702-3707 for each attribute. In block 3702, whether the attribute is a binary attribute, a categorical attribute, or a continuous range attribute is determined. In block 3703, attribute values of the attributes of the objects are retrieved from the attribute database. In decision block 3704, when the attribute is a binary attribute, control flows 3705. Otherwise, control flows to decision block 3706. In block 3705, a “map binary attribute values to pixel dimensions of features of object icons” procedure is performed. An example implementation of the “map binary attribute values to pixel dimensions of features of object icons” is described below with reference to FIG. 38. In decision block 3706, when the attribute is categorical attribute, control flows to block 3706. In block 3707, counts are computed for each category of the categorical attribute as described above with reference to FIG. 19C. In block 3708, a “map non-binary attribute values to pixel dimensions of features of object icons” procedure is performed. An example implementation of the “map non-binary attribute values to pixel dimensions of features of object icons” is described below with reference to FIG. 38. In decision block 3709, when another attribute is available the operations represented by blocks 3702-3708 are repeated.

FIG. 38 is a flow diagram illustrating an example implementation of the “map binary attribute values to pixel dimensions of features of object icons” procedure performed in block 3704 of FIG. 37. In block 3801, a first fraction, such as Fₚ, of first binary attribute values of the binary attribute are computed as described above with reference to FIG. 19A. In block 3802, a second fraction, such as F₁, of second binary attribute values of the binary attribute are computed as described above with reference to FIG. 19A. A loop beginning with block 3803 repeats the computational operations represented by blocks 3804-3806 for each object. In decision block 3804, when the binary value of the binary attribute is a first binary value as described above with reference to Equation (4a), control flows to block 3805. Otherwise, control flows to block 3806. In block 3805, a pixel dimension is computed for a feature of the object icon of the object based on the first fraction and minimum and maximum pixel dimensions for the feature as described above with reference to Equation (4b). In block 3806, a pixel dimension is computed for a feature of the object icon of the object based on the second fraction and minimum and maximum pixel dimensions for the feature as described above with reference to Equation (4b). In decision block 3807, the operations represented by blocks 3804-3806 are repeated for another object.

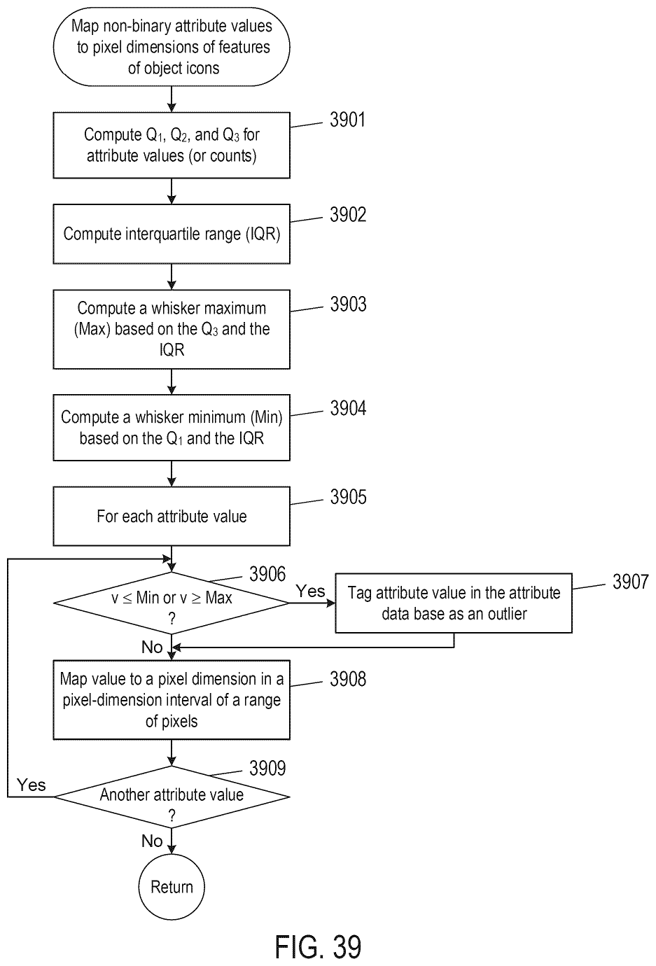

FIG. 39 is a flow diagram illustrating an example implementation of the “map non-binary attribute values to pixel dimensions of features of object icons” procedure performed in block 3707 of FIG. 37. In block 3901, median values Q₁. Q₂, and Q₃ are computed for the attribute values of the attribute as described above with reference to FIG. 19B. In block 3902, an interquartile range (“IQR”) is computed from the median Q₁ and the median Q₃ as described above with reference to Equation (1). In block 3903, a whisker maximum is computed based on the median Q₃ and the IQR as described above with reference to Equation (2b). In block 3903, a whisker minimum is computed based on the median Q₁ and the IQR as described above with reference to Equation (2a). A loop beginning with block 3905 repeats the computational operations represented by blocks 3906-3908 for each attribute value. In decision block 3906, when an attribute value satisfies one of the conditions given in Equations (3a) and (3b), control flows to block 3907 in which the attribute value is tagged in the attribute database as an outlier. In block 3908, the attribute value is mapped to a pixel dimension in a pixel-dimension interval of a range of pixels as described above with reference to Equation (5) and FIGS. 23 and 24. In decision block 3909, the operations represented by blocks 3906-3908 are repeated for another attribute value.

FIG. 40 is a flow diagram illustrating an example implementation of the “map binary attribute values to pixel dimensions of features of object icons” procedure performed in block 3604 of FIG. 36. In decision block 4001, when the cursor is detected as being placed over an object icon in the GUI, control flows to block 4002. In block 4002, an object represented by the object icon is identified. In block 4003, current attribute values for the object are retrieved from the attribute database. In block 4004, a pop-up window is created in the GUI. The attributes and corresponding attributes retrieved in block 4003 are displayed in the pop-up window. In decision block 4005, when any one or more of the attribute values retrieved in block 4003 includes an outlier tag, control flow to block 4006 in which the one or more attribute values tagged as outliers are highlighted in the pop-up window.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method, stored in one or more data-storage devices and executed using one or more processors of a computer system, for monitoring and visually representing attributes of objects executing in a data center, the method comprising:
updating attribute values in a database of attributes of the objects for a current time interval;
mapping the attribute values obtained in the current time interval to pixel dimensions of an electronic visual display device, the pixel dimensions corresponding to dimensions of features of object icons that represent the objects; and
displaying the object icons with the feature dimensions in a graphical user interface (“GUI”) on the electronic visual display device, the object icons revealing at a glance relative differences between attributes of the objects in the current time interval.

2. The method of claim 1 wherein mapping the attribute values obtained in the current time interval to pixel dimensions of an electronic visual display device comprises:
for each attribute of the objects
determining whether the attribute is a binary attribute, a categorical attribute, or a continuous range attribute;
retrieving attribute values of the binary attribute from the database:
mapping attribute values of the binary attribute to pixel dimensions of a feature of the object icons that corresponds to the binary attribute;
mapping attribute values of the categorical attribute to pixel dimensions of a feature of the object icons that corresponds to the categorical attribute; and
mapping attribute values of the continuous range attribute to pixel dimensions of a feature of the object icons that corresponds to the continuous range attribute.

3. The method of claim 1 wherein mapping the attribute values obtained in the current time interval to pixel dimensions of an electronic visual display device comprises:
determining whether the attribute is a binary attribute, a categorical attribute, or a continuous range attribute;
retrieving attribute values of the binary attribute from the database;
computing a fraction of a same binary value of a binary attribute; and
computing a pixel dimension for a feature of the object icon of the object based on the fraction and minimum and maximum pixel dimensions for the feature.

4. The method of claim 1 wherein mapping the attribute values obtained in the current time interval to pixel dimensions of an electronic visual display device comprises:
computing median value of the attribute values of the attribute;
computing a lower median value of attribute values that are less than the median value;
computing an upper median value of attribute values that are greater than the median value;
computing an interquartile range based on the upper median value and the lower median value;
computing a whisker maximum based on the upper median and the interquartile range;
computing a whisker minimum based on the lower median and the interquartile range; and
for each attribute value,
tagging an attribute value in the database as an outlier when the attribute value is greater than the whisker maximum or less than the whisker minimum, and
mapping the attribute value to a pixel dimension in a pixel-dimension interval of a range of pixels.

5. The method of claim 1 wherein mapping the attribute values obtained in the current time interval to pixel dimensions of an electronic visual display device comprises:
computing a count of attribute values in each category of a categorical attribute;
computing median count of the counts of attribute values;
computing a lower median count of the counts of attribute values that are less than the median count;
computing an upper median count of the counts of attribute values that are greater than the median count;
computing an interquartile range based on the upper median count and the lower median count;
computing a whisker maximum based on the upper median count and the interquartile range;
computing a whisker minimum based on the lower median count and the interquartile range; and
for each category,
tagging attribute values in a same category as outliers when the count of the category is greater than the whisker maximum or less than the whisker minimum, and
mapping the attribute values to a pixel dimension in a pixel-dimension interval of a range of pixels.

6. The method of claim 1 further comprising in response to a cursor placed over an object icon in the GUI,
retrieving attribute values of an object represented by the object icon from the database;
displaying a pop-up window in the GUI to display a list of the attributes and the corresponding attribute values; and
highlighting attribute values identified as outliers in the pop-up window.

7. A computer system for monitoring and visually representing attributes of objects executing in a data center, the computer system comprising:
one or more processors;
one or more data-storage devices;
an electronic visual display device; and
machine-readable instructions stored in the one or more data-storage devices that when executed using the one or more processors control the system to performance operations comprising:
updating attribute values in a database of attributes of the objects for a current time interval;
mapping the attribute values obtained in the current time interval to pixel dimensions of the electronic visual display device, the pixel dimensions corresponding to dimensions of features of object icons that represent the objects; and
displaying the object icons with the feature dimensions in a graphical user interface (“GUI”) on the electronic visual display device, the object icons revealing at a glance relative differences between attributes of the objects in the current time interval.

8. The system of claim 7 wherein mapping the attribute values obtained in the current time interval to pixel dimensions of an electronic visual display device comprises:
for each attribute of the objects
determining whether the attribute is a binary attribute, a categorical attribute, or a continuous range attribute;
retrieving attribute values of the binary attribute from the database;
mapping attribute values of the binary attribute to pixel dimensions of a feature of the object icons that corresponds to the binary attribute;
mapping attribute values of the categorical attribute to pixel dimensions of a feature of the object icons that corresponds to the categorical attribute; and
mapping attribute values of the continuous range attribute to pixel dimensions of a feature of the object icons that corresponds to the continuous range attribute.

9. The system of claim 7 wherein mapping the attribute values obtained in the current time interval to pixel dimensions of an electronic visual display device comprises:
determining whether the attribute is a binary attribute, a categorical attribute, or a continuous range attribute;
retrieving attribute values of the binary attribute from the database:
computing a fraction of a same binary value of a binary attribute; and
computing a pixel dimension for a feature of the object icon of the object based on the fraction and minimum and maximum pixel dimensions for the feature.

10. The system of claim 7 wherein mapping the attribute values obtained in the current time interval to pixel dimensions of an electronic visual display device comprises:
computing median value of the attribute values of the attribute;
computing a lower median value of attribute values that are less than the median value;
computing an upper median value of attribute values that are greater than the median value;
computing an interquartile range based on the upper median value and the lower median value;
computing a whisker maximum based on the upper median and the interquartile range;
computing a whisker minimum based on the lower median and the interquartile range; and
for each attribute value,
tagging an attribute value in the database as an outlier when the attribute value is greater than the whisker maximum or less than the whisker minimum, and
mapping the attribute value to a pixel dimension in a pixel-dimension interval of a range of pixels.

11. The system of claim 7 wherein mapping the attribute values obtained in the current time interval to pixel dimensions of an electronic visual display device comprises:
computing a count of attribute values in each category of a categorical attribute;
computing median count of the counts of attribute values;
computing a lower median count of the counts of attribute values that are less than the median count;
computing an upper median count of the counts of attribute values that are greater than the median count;
computing an interquartile range based on the upper median count and the lower median count;
computing a whisker maximum based on the upper median count and the interquartile range;
computing a whisker minimum based on the lower median count and the interquartile range; and
for each category,
tagging attribute values in a same category as outliers when the count of the category is greater than the whisker maximum or less than the whisker minimum, and
mapping the attribute values to a pixel dimension in a pixel-dimension interval of a range of pixels.

12. The system of claim 7 further comprising in response to a cursor placed over an object icon in the GUI,
retrieving attribute values of an object represented by the object icon from the database;
displaying a pop-up window in the GI to display a list of the attributes and the corresponding attribute values; and
highlighting attribute values identified as outliers in the pop-up window.

13. A non-transitory computer-readable medium having instructions encoded thereon for enabling one or more processors of a computer system to perform operations comprising:
updating attribute values in a database of attributes of the objects for a current time interval;
mapping the attribute values obtained in the current time interval to pixel dimensions of an electronic visual display device, the pixel dimensions corresponding to dimensions of features of object icons that represent the objects; and
displaying the object icons with the feature dimensions in a graphical user interface (“GUI”) on the electronic visual display device, the object icons revealing at a glance relative differences between attributes of the objects in the current time interval.

14. The medium of claim 13 wherein mapping the attribute values obtained in the current time interval to pixel dimensions of an electronic visual display device comprises:
for each attribute of the objects
determining whether the attribute is a binary attribute, a categorical attribute, or a continuous range attribute;
retrieving attribute values of the binary attribute from the database;
mapping attribute values of the binary attribute to pixel dimensions of a feature of the object icons that corresponds to the binary attribute;
mapping attribute values of the categorical attribute to pixel dimensions of a feature of the object icons that corresponds to the categorical attribute; and
mapping attribute values of the continuous range attribute to pixel dimensions of a feature of the object icons that corresponds to the continuous range attribute.

15. The medium of claim 13 wherein mapping the attribute values obtained in the current time interval to pixel dimensions of an electronic visual display device comprises:
determining whether the attribute is a binary attribute, a categorical attribute, or a continuous range attribute;
retrieving attribute values of the binary attribute from the database;
computing a fraction of a same binary value of a binary attribute; and
computing a pixel dimension for a feature of the object icon of the object based on the fraction and minimum and maximum pixel dimensions for the feature.

16. The medium of claim 13 wherein mapping the attribute values obtained in the current time interval to pixel dimensions of an electronic visual display device comprises:
computing median value of the attribute values of the attribute;
computing a lower median value of attribute values that are less than the median value;
computing an upper median value of attribute values that are greater than the median value;
computing an interquartile range based on the upper median value and the lower median value;
computing a whisker maximum based on the upper median and the interquartile range;
computing a whisker minimum based on the lower median and the interquartile range; and
for each attribute value,
tagging an attribute value as an outlier when the attribute value is greater than the whisker maximum or less than the whisker minimum, and
mapping the attribute value to a pixel dimension in a pixel-dimension interval of a range of pixels.

17. The medium of claim 13 wherein mapping the attribute values obtained in the current time interval to pixel dimensions of an electronic visual display device comprises:
computing a count of attribute values in each category of a categorical attribute;
computing median count of the counts of attribute values;
computing a lower median count of the counts of attribute values that are less than the median count;
computing an upper median count of the counts of attribute values that are greater than the median count;
computing an interquartile range based on the upper median count and the lower median count;
computing a whisker maximum based on the upper median count and the interquartile range;
computing a whisker minimum based on the lower median count and the interquartile range; and
for each category,
tagging attribute values in the database in a same category as outliers when the count of the category is greater than the whisker maximum or less than the whisker minimum, and
mapping the attribute values to a pixel dimension in a pixel-dimension interval of a range of pixels.

18. The medium of claim 13 further comprising in response to a cursor placed over an object icon in the GUI,
retrieving attribute values of an object represented by the object icon from the database;
displaying a pop-up window in the GUI to display a list of the attributes and the corresponding attribute values; and
highlighting attribute values identified as outliers in the pop-up window.
